(19) United States
(12) Patent Application Publication
(10) Pub. No.: US 2026/0063979 A1
(43) Pub. Date: Mar. 5, 2026

(54) LIGHT SOURCE DEVICE AND PROJECTOR

(71) Applicant: SEIKO EPSON CORPORATION, Tokyo (JP)

(72) Inventor: Ryota TAKAI, MATSUMOTO-SHI (JP)

(21) Appl. No.: 19/314,637

(22) Filed: Aug. 29, 2025

(30) Foreign Application Priority Data
Sep. 2, 2024 (JP) 2024-150751

(51) Int. Cl. G03B 21/16; G03B 21/20

(52) U.S. Cl. CPC G03B 21/16; G03B 21/204

(57) ABSTRACT

A light source device according to an aspect of the present disclosure includes a light source unit including a light emitting element configured to emit light, a light guide member on which the light emitted from the light emitting element is made incident, the light guide member emitting the light, and a support member configured to support the light guide member. The support member includes a support surface facing a first direction intersecting a longitudinal direction, which is a direction in which the light guide member extends, and configured to support the light guide member, a heat transfer member extending in a second direction intersecting the longitudinal direction, and a holding section configured to hold the heat transfer member, the heat transfer member is disposed on the inside of the holding section, and the thermal conductivity of the heat transfer member is higher than the thermal conductivity of the holding section.

The present application is based on, and claims priority from JP Application Serial Number 2024-150751, filed Sep. 2, 2024, the disclosure of which is hereby incorporated by reference herein in its entirety.

### BACKGROUND

### 1. Technical Field

The present disclosure relates to a light source device and a projector.

### 2. Related Art

As a light source device used in a projector, there has been proposed a light source device that emits fluorescence emitted from a phosphor when a phosphor rod is irradiated with excitation light emitted from a light emitting element. WO 2020/254455 described below discloses a light source device having a configuration in which a phosphor rod is fixed to a metal holder by an elastic member such as a spring. In the light source device having the configuration explained above, heat generated when the phosphor rod emits fluorescence is transferred to the holder and radiated from the outer surface of the holder.

WO 2020/254455 is an example of the related art.

In the technique described in WO 2020/254455, since the phosphor rod is rod-shaped, it is difficult for the phosphor rod to transfer, to the holder, heat generated in the phosphor rod in a direction intersecting the longitudinal direction of the phosphor rod. Therefore, the temperature of the phosphor rod is likely to be excessively high. When the temperature of the phosphor rod is excessively high, temperature quenching of the fluorescence is likely to increase in the phosphor rod. For that reason, wavelength conversion efficiency, which is efficiency of the phosphor rod converting excitation light into fluorescence, is likely to decrease.

### SUMMARY

According to an aspect of the present disclosure, there is provided a light source device including: a light source unit including a light emitting element configured to emit light; a light guide member on which the light emitted from the light emitting element is made incident, the light guide member emitting the light; and a support member configured to support the light guide member, wherein the support member includes: a support surface facing a first direction intersecting a longitudinal direction, which is a direction in which the light guide member extends, and configured to support the light guide member; a heat transfer member extending in a second direction intersecting the longitudinal direction; and a holding section configured to hold the heat transfer member, the heat transfer member is disposed on an inside of the holding section, and thermal conductivity of the heat transfer member is higher than thermal conductivity of the holding section.

A projector according to an aspect of the present disclosure includes: the light source device according to the aspect of the present disclosure; a light modulation device configured to modulate light emitted from the light source device; and a projection optical device configured to project the light modulated by the light modulation device.

### BRIEF DESCRIPTION OF THE DRAWINGS

FIG. 1 is a schematic configuration diagram of a projector in an embodiment.

FIG. 2 is a schematic configuration diagram of a first illumination device.

FIG. 3 is a plan view of a light source device viewed from a first direction.

FIG. 4 is a cross-sectional view of the light source device taken along a IV-IV line in FIG. 3.

FIG. 5 is a cross-sectional view of the light source device taken along a V-V line in FIG. 3.

FIG. 6 is a cross-sectional view of the light source device taken along a VI-VI line in FIG. 3.

FIG. 7 is a plan view of a light source device in a second embodiment viewed from the first direction.

FIG. 8 is a cross-sectional view of the light source device taken along a VIII-VIII line in FIG. 7.

FIG. 9 is a plan view of a light source device in a third embodiment viewed from the first direction.

FIG. 10 is a cross-sectional view of the light source device taken along a X-X line in FIG. 9.

FIG. 11 is a plan view of a light source device in a fourth embodiment viewed from the first direction.

FIG. 12 is a cross-sectional view of the light source device taken along a XII-XII line in FIG. 11.

FIG. 13 is a cross-sectional view illustrating a light source device in a fifth embodiment.

FIG. 14 is a cross-sectional view illustrating a light source device in a sixth embodiment.

### DESCRIPTION OF EMBODIMENTS

Embodiments of the present disclosure are explained below.

Projectors in the embodiments are examples of a projector in which a liquid crystal panel is used as a light modulation device.

In the drawings referred to below, elements are sometimes illustrated with scales of dimensions differentiated depending on the elements in order to make the elements to easy see.

In the drawings, explanation is made below using an XYZ orthogonal coordinate system according to necessity. An X axis is an axis extending in a direction in which a light guide member in the embodiments explained below extends. In the following explanation, a direction in which the X axis extends (an X-axis direction) is sometimes referred to as “longitudinal direction”. A Z axis is an axis orthogonal to the X axis. The Z axis is an axis extending along the up-down direction of the projector. In the following explanation, a direction in which the Z axis extends is referred to as Z-axis direction. A Y axis is an axis orthogonal to both of the X axis and the Z axis. In the following explanation, a direction in which the Y axis extends (a Y-axis direction) is sometimes referred to as “incident direction”. The incident direction is a direction in which first light is made incident on the light guide member. In the following explanation, a side that an arrow of the X axis faces is referred to as +X side, a side opposite to the +X side is referred to as −X side, a side that an arrow of the Y axis faces is referred to as +Y side, a side opposite to the +Y side is referred to as −Y side, a side that an arrow of the Z axis faces is referred to as +Z side, and a side opposite to the +Z side is referred to as −Z side.

Hereinafter, in the drawings, a first direction D1 and a second direction D2 are illustrated according to necessity. The first direction D1 is a direction that a support surface of a support member faces. The first direction D1 is a direction intersecting the longitudinal direction. In the following explanation, a side that an arrow in the first direction D1 faces is referred to as +D1 side and a side opposite to the +D side is referred to as-D1 side. The second direction D2 is a direction in which a heat transfer member extends. The second direction D2 is a direction intersecting the longitudinal direction. In the following explanation, a side that an arrow in the second direction D2 faces is referred to as +D2 side and a side opposite to the +D2 side is referred to as −D2 side.

### First Embodiment

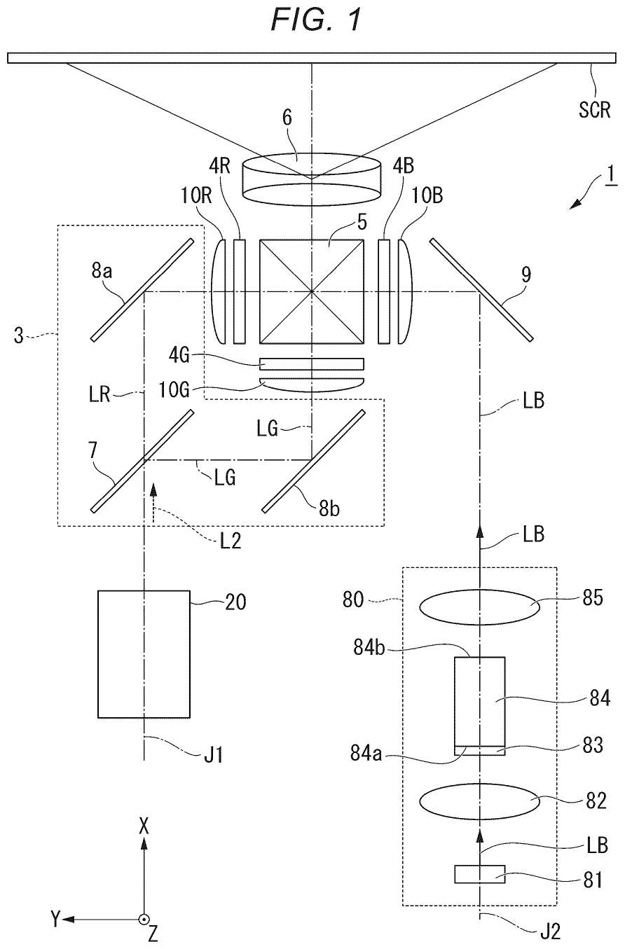

FIG. 1 is a schematic configuration diagram of a projector 1 in the present embodiment. The projector 1 is a projection-type image display device that displays a color image on a screen SCR, which is a projection surface, as illustrated in FIG. 1. The projector 1 includes three light modulation devices 4R, 4G, and 4B corresponding to colored lights, that is, red light LR, green light LG, and blue light LB. The projector 1 includes a first illumination device 20, a second illumination device 80, a color separation optical system 3, the light modulation devices 4R, 4G, and 4B, a light combining element 5, and a projection optical device 6.

The first illumination device 20 emits yellow second light L2 toward the color separation optical system 3. The second light L2 is light emitted from a light source device 21 provided in the first illumination device 20. The second illumination device 80 emits the blue light LB toward the light modulation device 4B. Detailed configurations of the first illumination device 20 and the second illumination device 80 are explained below.

A first optical axis J1 illustrated in the drawings as appropriate is the central axis of the second light L2 emitted from the first illumination device 20. A second optical axis J2 illustrated in FIG. 1 is the central axis of the blue light LB emitted from the second illumination device 80. The first optical axis J1 and the second optical axis J2 extend in a direction parallel to the longitudinal direction (the X-axis direction).

The color separation optical system 3 separates the yellow second light L2 emitted from the first illumination device 20 into the red light LR and the green light LG. The color separation optical system 3 includes a dichroic mirror 7, a first reflection mirror 8a, and a second reflection mirror 8b.

The dichroic mirror 7 separates the second light L2 into the red light LR and the green light LG. The dichroic mirror 7 transmits the red light LR and reflects the green light LG. The second reflection mirror 8b is disposed in an optical path of the green light LG. The second reflection mirror 8b reflects the green light LG, which is reflected by the dichroic mirror 7, toward the light modulation device 4G. The first reflection mirror 8a is disposed in an optical path of the red light LR. The first reflection mirror 8a reflects the red light LR, which has passed through the dichroic mirror 7, toward the light modulation device 4R.

The blue light LB emitted from the second illumination device 80 is reflected by a reflection mirror 9 toward the light modulation device 4B. The second illumination device 80 includes a second light source unit 81, a condensing lens 82, a diffusion plate 83, a rod lens 84, and a relay lens 85. The second light source unit 81 includes at least one semiconductor laser. The second light source unit 81 emits the blue light LB including laser light toward the condensing lens 82. Note that the second light source unit 81 is not limited to the semiconductor laser and may include an LED that emits blue light.

The condensing lens 82 includes a convex lens. The condensing lens 82 makes the blue light LB emitted from the second light source unit 81 incident on the diffusion plate 83 in a condensed state. The diffusion plate 83 diffuses the blue light LB emitted from the condensing lens 82 at a predetermined diffusion degree to thereby generate the blue light LB having a uniform light distribution. The diffusion plate 83 includes, for example, ground glass made of optical glass.

The blue light LB diffused by the diffusion plate 83 is made incident on the rod lens 84. The rod lens 84 has a prism shape extending along a direction of the second optical axis J2. The rod lens 84 includes a light incident end face 84a provided at one end and a light emission end face 84b provided at the other end. The diffusion plate 83 is fixed to the light incident end face 84a of the rod lens 84 via an optical adhesive (not illustrated). The refractive index of the diffusion plate 83 and the refractive index of the rod lens 84 are desirably matched as much as possible.

The blue light LB propagates through the inside of the rod lens 84 while being totally reflected to be emitted from the light emission end face 84b in a state in which the uniformity of illuminance distribution is enhanced. The blue light LB emitted from the rod lens 84 is made incident on the relay lens 85. The relay lens 85 makes the blue light LB, the uniformity of the illuminance distribution of which is enhanced by the rod lens 84, incident on the reflection mirror 9. The shape of the light emission end face 84b of the rod lens 84 is a rectangular shape substantially similar to the shape of an image formation region of the light modulation device 4B. Accordingly, the blue light LB emitted from the rod lens 84 is efficiently made incident on the image formation region of the light modulation device 4B.

The light modulation device 4R modulates the red light LR according to image information to form image light corresponding to the red light LR. The light modulation device 4G modulates the green light LG according to the image information to form image light corresponding to the green light LG. The light modulation device 4B modulates the blue light LB according to the image information to form image light corresponding to the blue light LB. As the light modulation devices 4R, 4G, and 4B, for example, a transmissive liquid crystal panel can be used. Not illustrated polarizing plates are disposed on an incident side and an emission side of the light modulation devices 4R, 4G, and 4B. The polarizing plates allow only linearly polarized light in a specific direction to pass. The red light LR and the green light LG are lights obtained by separating the second light L2 with the dichroic mirror 7 as explained above. Thus, the light modulation devices 4R and 4G modulate the second light L2, that is, the light emitted from the light source device 21.

A field lens 10R is disposed on the incident side of the light modulation device 4R. The field lens 10R collimates a principal ray of the red light LR made incident on the light modulation device 4R. A field lens 10G is disposed on the incident side of the light modulation device 4G. The field lens 10G collimates a principal ray of the green light LG made incident on the light modulation device 4G. A field lens 10B is disposed on the incident side of the light modulation device 4B. The field lens 10B collimates a principal ray of the blue light LB made incident on the light modulation device 4B.

The light combining element 5 combines the image lights modulated by the light modulation devices 4R, 4G, and 4B and emits the combined image light toward the projection optical device 6. As the light combining element 5, for example, a cross dichroic prism can be used.

The projection optical device 6 includes a not-illustrated plurality of projection lenses. The projection optical device 6 projects the image light combined in the light combining element 5 toward the screen SCR in an enlarged manner. The projection optical device 6 projects the lights modulated by the light modulation devices 4R, 4G, and 4B toward the screen SCR. Accordingly, a color image is displayed on the screen SCR.

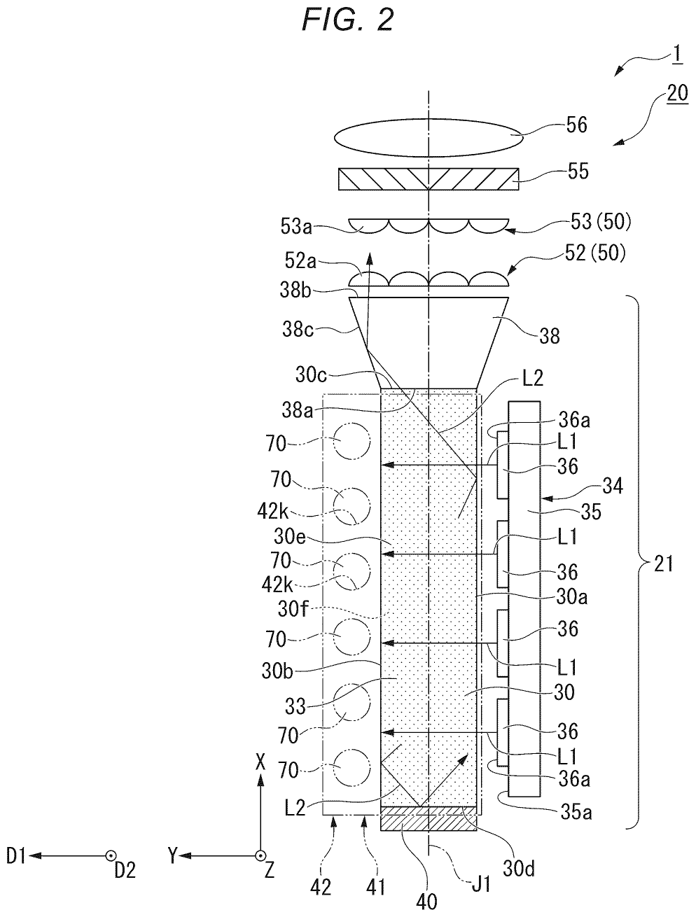

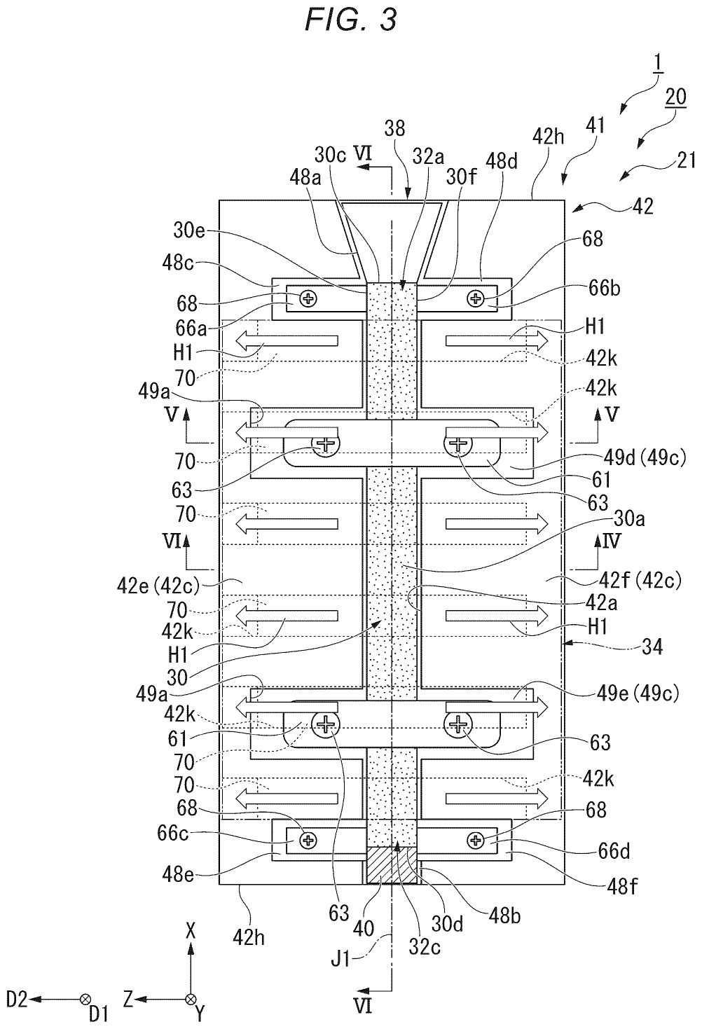

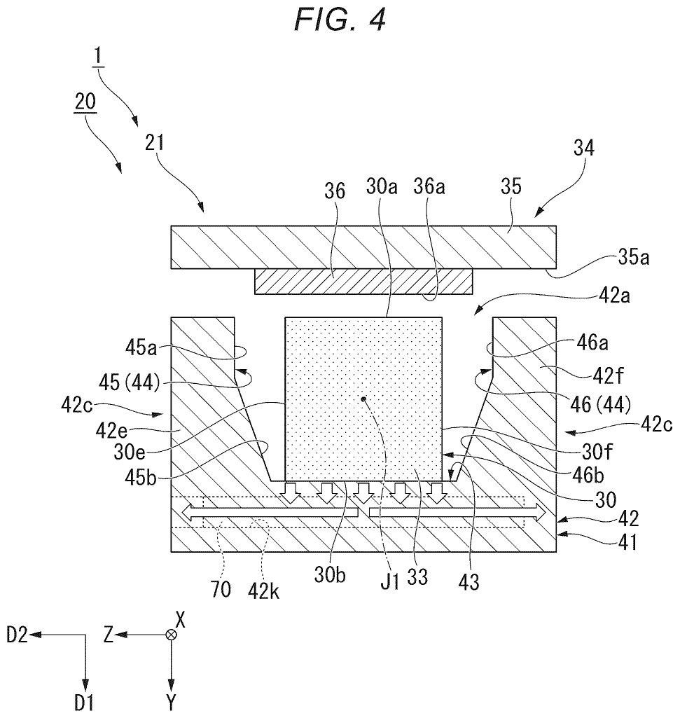

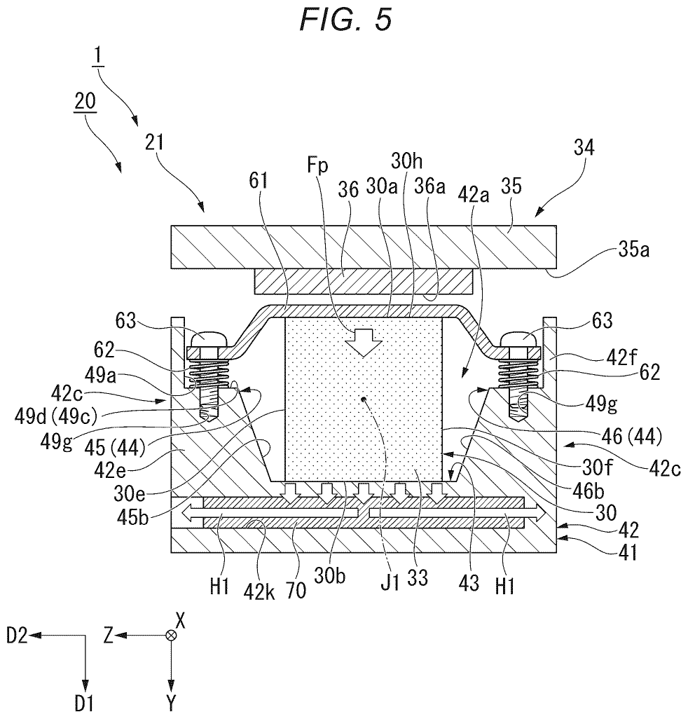

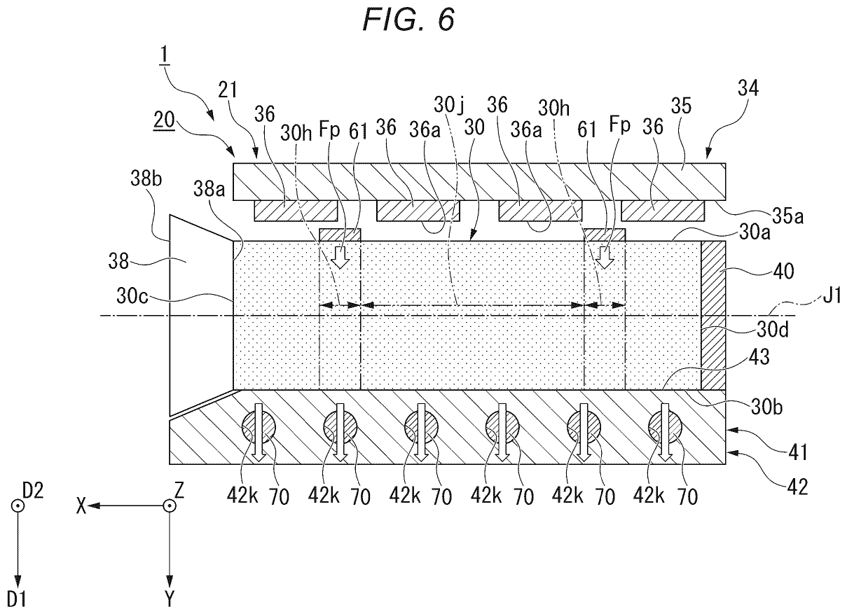

FIG. 2 is a schematic configuration diagram of the first illumination device 20. FIG. 3 is a plan view of the light source device 21 viewed from the first direction D1. FIG. 4 is a cross-sectional view of the light source device 21 taken along a IV-IV line in FIG. 3. FIG. 5 is a cross-sectional view of the light source device 21 taken along a V-V line in FIG. 3. FIG. 6 is a cross-sectional view of the light source device 21 taken along a VI-VI line in FIG. 3. As illustrated in FIG. 2, the first illumination device 20 includes the light source device 21, an integrator optical system 50, a polarization conversion element 55, and a superimposing optical system 56. That is, the projector 1 includes the light source device 21.

In the present embodiment, the first direction D1 is a direction parallel to the incident direction (the Y-axis direction). The first direction D1 is orthogonal to the longitudinal direction (the X-axis direction). In the present embodiment, the second direction D2 is a direction intersecting both of the longitudinal direction and the first direction D1. In the present embodiment, the second direction D2 is a direction parallel to the Z-axis direction. In the present embodiment, the second direction D2 is orthogonal to both of the longitudinal direction and the first direction D1. The second direction D2 may not be orthogonal to at least one of the longitudinal direction and the first direction D1. In this case, an angle between the second direction D2 and the longitudinal direction only has to be 45° or more.

The light source device 21 converts first light L1 into the yellow second light L2 and emits the second light L2 toward the integrator optical system 50. The light source device 21 includes a wavelength conversion member 30, a light source unit 34, an angle conversion member 38, a mirror 40, and a support member 41. As illustrated in FIG. 3, the light source device 21 includes a pressing member 61. The wavelength conversion member 30 in the present embodiment corresponds to a “light guide member” in the claims. Therefore, the light source device 21 includes a light guide member.

The wavelength conversion member 30 has a quadrangular prism shape extending in the longitudinal direction (the X-axis direction) and includes six surfaces. The dimension in the longitudinal direction of the wavelength conversion member 30 is larger than each of the dimension in the incident direction (the Y-axis direction) and the dimension in the Z-axis direction. The dimension in the incident direction and the dimension in the Z-axis direction of the wavelength conversion member 30 are substantially the same dimension. Thus, the cross-sectional shape of the wavelength conversion member 30 cut along a surface orthogonal to the longitudinal direction is a substantially square shape. The cross-sectional shape of the wavelength conversion member 30 cut along a surface orthogonal to the longitudinal direction may be another shape such as a rectangular shape. The wavelength conversion member 30 may not always have the quadrangular prism shape and may have a shape such as a triangular prism shape or a cylindrical shape.

The wavelength conversion member 30 includes a first surface 30a and a second surface 30b that are orthogonal to the incident direction (the Y-axis direction) and are located on the opposite sides in the incident direction each other. The second surface 30b is located further on the +Y side than the first surface 30a. The first surface 30a and the second surface 30b face the opposite sides each other.

The wavelength conversion member 30 includes a third surface 30c and a fourth surface 30d that are orthogonal to the longitudinal direction (the X-axis direction) and are located on the opposite sides in the longitudinal direction each other. The fourth surface 30d is located further on the −X side than the third surface 30c. The third surface 30c and the fourth surface 30d face the opposite sides each other.

As illustrated in FIG. 4, the wavelength conversion member 30 includes a fifth surface 30e and a sixth surface 30f that are orthogonal to the Z-axis direction and are located on the opposite sides in the Z-axis direction each other. The sixth surface 30f is located further on the −Z side than the fifth surface 30e. The fifth surface 30e and the sixth surface 30f face the opposite sides each other.

As illustrated in FIG. 2, the wavelength conversion member 30 includes a phosphor 33 and converts the first light L1 having a first wavelength band and emitted from the light source unit 34 into the second light L2 having a second wavelength band different from the first wavelength band. The wavelength conversion member 30 emits the second light L2 toward the angle conversion member 38. The first light L1 is emitted from the light source unit 34 in the incident direction (the Y-axis direction) and is made incident on the wavelength conversion member 30 from the first surface 30a. The second light L2 is guided on the inside of the wavelength conversion member 30 and is emitted from the third surface 30c toward the angle conversion member 38.

In the present embodiment, the phosphor 33 is a ceramic phosphor made of a polycrystalline phosphor that converts the first light L1 into the second light L2. The second wavelength band of the second light L2 is, for example, a yellow wavelength band of 490 nm to 900 nm. That is, the second light L2 is yellow fluorescence containing a red light component and a green light component. Note that the phosphor 33 may be a single crystal phosphor. The wavelength conversion member 30 may include fluorescent glass. The wavelength conversion member 30 may be made of a material obtained by dispersing a large number of phosphor particles in a binder made of glass or resin.

In the present embodiment, the wavelength conversion member 30 contains, for example, an yttrium aluminum garnet (YAG)-based phosphor. Consider YAG: Ce, which contains cerium (Ce) as an activator, by way of example, as the wavelength conversion member 30, for example, a material obtained by mixing raw material powder containing constituent elements such as Y₂O₃, Al₂O₃, and CeO₃ and causing the mixture to go through a solid phase reaction, Y—Al—O amorphous particles obtained by a wet method such as a coprecipitation method or a sol-gel method, or YAG particles obtained by a gas-phase method such as a spray-drying method, a flame-based thermal decomposition method, or a thermal plasma method are used.

When the first light L1 is made incident on the wavelength conversion member 30, the phosphor 33 absorbs the first light L1 and emits the second light L2 having the second wavelength band. Accordingly, the wavelength conversion member 30 converts the first light L1 into the second light L2. Note that, when the phosphor 33 absorbs the first light L1, the phosphor 33 generates heat. Accordingly, the temperature of the wavelength conversion member 30 rises.

The light source unit 34 irradiates the wavelength conversion member 30 with the first light L1. The light source unit 34 is disposed to face the first surface 30a of the wavelength conversion member 30 in the incident direction (the Y-axis direction). As illustrated in FIG. 4, the light source unit 34 includes a substrate 35 and a light emitting element 36. The light source unit 34 may include other optical members such as a light guide plate, a diffusion plate, and a lens.

The substrate 35 has a plate shape spreading in directions orthogonal to the incident direction (the Y-axis direction). When viewed from the incident direction, the substrate 35 has a substantially rectangular shape, long sides of which extend in the longitudinal direction (the X-axis direction). The substrate 35 includes a surface 35a. The surface 35a is a surface facing the +Y side among outer surfaces of the substrate 35. The surface 35a faces the wavelength conversion member 30 in the incident direction.

The light emitting element 36 is mounted on the surface 35a of the substrate 35. The light emitting element 36 includes, for example, a light emitting diode (LED). The light emitting element 36 includes a light emitting surface 36a. The light emitting surface 36a faces the first surface 30a of the wavelength conversion member 30 in the incident direction (the Y-axis direction). The light emitting element 36 emits the first light L1 having the first wavelength band, that is light, from the light emitting surface 36a toward the first surface 30a of the wavelength conversion member 30. Accordingly, the first light L1 emitted from the light emitting element 36 is made incident on the wavelength conversion member 30. As illustrated in FIG. 2, the wavelength conversion member 30 converts the first light L1 into the second light L2 and emits the second light L2. In the present embodiment, the first wavelength band is, for example, a wavelength band of blue to purple at 400 nm to 480 nm. A peak wavelength of the first light L1 is, for example, 445 nm.

The light source unit 34 includes a plurality of light emitting elements 36. In the present embodiment, the light source unit 34 includes four light emitting elements 36. The light emitting elements 36 are disposed spaced apart in the longitudinal direction (the X-axis direction). The light emitting elements 36 face the first surface 30a in the incident direction (the Y-axis direction). The number of the light emitting elements 36 provided in the light source unit 34 is not particularly limited and may be three or less or may be five or more.

The support member 41 supports the wavelength conversion member 30, that is, the light guide member. The heat generated in the wavelength conversion member 30 is transferred to the support member 41. The heat is radiated to the outside of the light source device 21. As illustrated in FIG. 5, the support member 41 includes a holding section 42 and a heat transfer member 70.

As illustrated in FIG. 6, the holding section 42 extends in the longitudinal direction (the X-axis direction) and holds the wavelength conversion member 30. The heat generated in the wavelength conversion member 30 is transferred to the holding section 42. The heat is radiated to the outside of the light source device 21 from the outer surface of the holding section 42. For that reason, the holding section 42 is desirably made of a material having predetermined strength and high thermal conductivity. As a material of the holding section 42, aluminum, stainless steel, and the like can be used and it is particularly desirable to use an aluminum alloy such as 6061 series. In the present embodiment, the holding section 42 is made of aluminum. As illustrated in FIG. 4, the holding section 42 has a U shape when viewed in the longitudinal direction. As illustrated in FIG. 3, the holding section 42 includes a support groove 42a, a side wall section 42c, a first housing section 48a, a second housing section 48b, a third housing section 48c, a fourth housing section 48d, a fifth housing section 48e, a sixth housing section 48f, a recess 49a, and a fixed section 49f. As illustrated in FIG. 6, the holding section 42 includes a housing hole 42k.

As illustrated in FIG. 4, the support groove 42a is a groove recessed to the +Y side from a surface facing the −Y side of the holding section 42. As illustrated in FIG. 3, the support groove 42a extends in the longitudinal direction (the X-axis direction). The wavelength conversion member 30 is housed in the support groove 42a. As illustrated in FIG. 4, the support groove 42a includes a support surface 43 and a side wall surface 44. That is, the support member 41 includes the support surface 43.

The support surface 43 is a surface facing the −Y side among the inner surfaces of the support groove 42a. That is, the support surface 43 is a surface facing the −D1 side. That is, the support surface 43 faces the first direction D1. The support surface 43 supports the second surface 30b of the wavelength conversion member 30 in the incident direction (the Y-axis direction). Accordingly, the support surface 43 supports the wavelength conversion member 30. Heat generated in the wavelength conversion member 30 is transferred to the holding section 42 via the support surface 43.

The side wall section 42c is, in the holding section 42, a portion facing the wavelength conversion member 30 in the Z-axis direction. In the present embodiment, the holding section 42 includes two side wall sections 42c. The two side wall sections 42c include a first side wall section 42e and a second side wall section 42f.

The first side wall section 42e is, in the holding section 42, a portion located further on the +Z side than the support groove 42a. The first side wall section 42e faces the fifth surface 30e of the wavelength conversion member 30 with a gap in the Z direction. The second side wall section 42f is, in the holding section 42, a portion located further on the −Z side than the support groove 42a. The second side wall section 42f faces the sixth surface 30f of the wavelength conversion member 30 with a gap in the Z direction.

The side wall surface 44 is a surface facing the wavelength conversion member 30 in the Z-axis direction among the inner surfaces of the support groove 42a. In the present embodiment, the support groove 42a includes two side wall surfaces 44. The two side wall surfaces 44 include a first side wall surface 45 and a second side wall surface 46.

The first side wall surface 45 is a surface facing the −Z side among the outer surfaces of the first side wall section 42e. The first side wall surface 45 faces the fifth surface 30e of the wavelength conversion member 30. The first side wall surface 45 includes a first side surface section 45a located on a side far from the support surface 43 and a second side surface section 45b located on a side close to the support surface 43. The first side surface section 45a spreads in a direction perpendicular to the support surface 43. The second side surface section 45b is an inclined surface that approaches the wavelength conversion member 30 as approaching the support surface 43.

The second side wall surface 46 is a surface facing the +Z side among the outer surfaces of the second side wall section 42f. The second side wall surface 46 faces the sixth surface 30f of the wavelength conversion member 30. The second side wall surface 46 includes a third side surface section 46a located on a side far from the support surface 43 and a fourth side surface section 46b located on a side close to the support surface 43. The third side surface section 46a spreads in a direction perpendicular to the support surface 43. The fourth side surface section 46b is an inclined surface that approaches the wavelength conversion member 30 as approaching the support surface 43.

As illustrated in FIG. 3, the first housing section 48a is a recess communicating with the end portion on the +X side of the support groove 42a. The first housing section 48a penetrates to an outer edge 42h on the +X side of the holding section 42. The first housing section 48a houses a first protruding section 32a of the wavelength conversion member 30 protruding from the support groove 42a to the +X side. The first housing section 48a holds the angle conversion member 38 fixed to the third surface 30c of the wavelength conversion member 30.

The second housing section 48b is a recess communicating with the end portion on the −X side of the support groove 42a. The second housing section 48b penetrates to the outer edge 42h on the −X side of the holding section 42. The second housing section 48b houses a second protruding section 32c of the wavelength conversion member 30 protruding from the support groove 42a to the −X side. The second housing section 48b houses the mirror 40 provided on the fourth surface 30d of the wavelength conversion member 30.

The third housing section 48c is a recess extending from the first housing section 48a to the +Z side. The third housing section 48c houses a position restricting section 66a that holds a portion on the +Z side of the first protruding section 32a.

The fourth housing section 48d is a recess extending from the first housing section 48a to the −Z side. The fourth housing section 48d houses a position restricting section 66b that holds a portion on the −Z side of the first protruding section 32a.

The fifth housing section 48e is a recess extending in the +Z direction from the second housing section 48b. The fifth housing section 48e houses position restricting section 66c that holds a portion on the +Z side of the second protruding section 32c.

The sixth housing section 48f is a recess extending in the −Z direction from the second housing section 48b. The sixth housing section 48f houses a position restricting section 66d that holds a portion on the −Z side of the second protruding section 32c.

The position restricting sections 66a, 66b, 66c, and 66d hold the first protruding section 32a or the second protruding section 32c protruding in the longitudinal direction (the X-axis direction) from the support groove 42a of the holding section 42 and restrict the position of the wavelength conversion member 30 with respect to the support groove 42a. The position restricting sections 66a, 66b, 66c, and 66d are fixed to the holding section 42 by screws 68. Note that the positions of the position restricting sections 66a, 66b in the Z-axis direction with respect to one another can be adjusted by a not-illustrated adjustment mechanism. Similarly, the positions of the position restricting sections 66c, 66d in the Z-axis direction with respect to one another can be adjusted by a not-illustrated adjustment mechanism.

As illustrated in FIG. 5, the recess 49a is a hole recessed to the +Y side from a surface facing the −Y side of the holding section 42. More specifically, the recess 49a is a hole recessed to the +Y side from each of the surface of the first side wall section 42e facing the −Y side and the surface of the second side wall section 42f facing the −Y side. The inside of the recess communicates with the inside of the support groove 42a. The dimension of the first recess 49a in the incident direction (the Y-axis direction) is smaller than the dimension of the support groove 42a in the incident direction. The dimension of the recess 49a in the Z-axis direction is larger than the dimension of the support groove 42a in the Z-axis direction. As illustrated in FIG. 3, when viewed from the incident direction, the first recess 49a has a substantially rectangular shape, long sides of which extend in the Z-axis direction. The holding section 42 includes a plurality of recesses 49a. In the present embodiment, the holding section 42 includes two recesses 49a. The recesses 49a are disposed spaced apart from one another in the longitudinal direction (the X-axis direction).

As illustrated in FIG. 5, the fixed section 49c is a surface facing the −Y side among the inner surfaces of the recess 49a. More specifically, the fixed section 49c includes a surface facing the −Y side of the first side wall section 42e and a surface facing the −Y side of the second side wall section 42f. The pressing member 61 is fixed to the fixed section 49c. As illustrated in FIG. 3, the holding section 42 includes a plurality of fixed sections 49c. In the present embodiment, the holding section 42 includes two fixed sections 49c. Pressing members 61 different from each other are fixed to the fixed sections 49c. The two fixed sections 49c include a first fixed section 49d and a second fixed section 49e.

The first fixed section 49d is a surface facing the −Y side of, of the two recesses 49a, the recess 49a located on the +X side. The second fixed section 49e is a surface facing the −Y side of, of the two recesses 49a, the recess 49a located on the −X side. The first fixed section 49d and the second fixed section 49e are disposed at an interval from each other in the longitudinal direction (the X-axis direction). That is, the plurality of fixed sections 49c are disposed spaced apart from one another in the longitudinal direction. As illustrated in FIG. 5, two hole sections 49g are provided in each of the fixed sections 49c. The hole sections 49g are female screw holes recessed from the fixed section 49c to the +Y side. In each of the fixed sections 49c, one hole section 49g is recessed to the +Y side from a surface facing the −Y side of the first side wall section 42e. In each of the fixed sections 49c, the other hole section 49g is recessed to the +Y side from a surface facing the −Y side of the second side wall section 42f. The two hole sections 49g provided in each of the fixed sections 49c are provided in the Z-axis direction across the support groove 42a.

As illustrated in FIG. 5, the housing hole 42k is a hole recessed to the −D2 side from a surface facing the +D2 side of the holding section 42. That is, the housing hole 42k is a hole extending in the second direction D2. The housing hole 42k may be a hole penetrating the holding section 42 in the second direction D2. The housing hole 42k is provided further on the +D1 side than the support groove 42a. As illustrated in FIG. 6, the housing hole 42k has a substantially circular shape when viewed from the second direction D2. When viewed from the second direction D2, the housing hole 42k may have another shape such as a triangular shape or a quadrangular shape. The heat transfer member 70 is housed in the housing hole 42k. The holding section 42 includes a plurality of housing holes 42k. In the present embodiment, the holding section 42 includes six housing holes 42k. The number of housing holes 42k of in the holding section 42 may be five or less or may be seven or more. The housing holes 42k are provided spaced apart from one another in the longitudinal direction (the X-axis direction). As illustrated in FIG. 3, when viewed from the first direction D1, parts of the housing holes 42k overlap the wavelength conversion member 30.

As illustrated in FIG. 2, the mirror 40 is provided on the fourth surface 30d of the wavelength conversion member 30. The mirror 40 reflects, toward the third surface 30c, the second light L2 which was guided on the inside of the wavelength conversion member 30 and reached the fourth surface 30d. The mirror 40 includes a metal film or a dielectric multilayer film formed at the fourth surface 30d of the wavelength conversion member 30.

The first light L1 emitted from the light emitting element 36 toward the first surface 30a is made incident on the wavelength conversion member 30 via the first surface 30a. When the first light L1 is made incident on the inside of the wavelength conversion member 30, the phosphor 33 is excited by the first light L1 and emits the second light L2. The second light L2 travels radially centering on the phosphor 33. The second light L2 traveling toward each of the first surface 30a, the second surface 30b, the fifth surface 30e, and the sixth surface 30f of the wavelength conversion member 30 travels toward the third surface 30c or the fourth surface 30d while repeating total reflection on the surfaces 30a, 30b, 30e, and 30f. The second light L2 traveling toward the fourth surface 30d is reflected by the mirror 40 and travels toward the third surface 30c. Accordingly, the second light L2 emitted in the phosphor 33 travels toward the third surface 30c and is transmitted through the third surface 30c and made incident on the angle conversion member 38. Note that, as explained above, when the phosphor 33 absorbs the first light L1, the phosphor 33 generates heat. Accordingly, the temperature of the wavelength conversion member 30 rises.

The angle conversion member 38 is provided on the emission side of the third surface 30c of the wavelength conversion member 30. The second light L2 emitted from the third surface 30c is made incident on the angle conversion member 38. The angle conversion member 38 includes, for example, a light transmissive member such as a tapered rod. The angle conversion member 38 includes an incident surface 38a on which the second light L2 emitted from the wavelength conversion member 30 is made incident, an emission surface 38b from which the second light L2 is emitted, and a reflection side surface 38c that reflects the second light L2 toward the emission surface 38b. The incident surface 38a faces the third surface 30c in the longitudinal direction (the X-axis direction).

The angle conversion member 38 has a truncated quadrangular pyramidal shape. The cross-sectional area thereof orthogonal to the first optical axis J1 increases in the traveling direction of the second light L2. Therefore, the area of the emission surface 38b is larger than the area of the incident surface 38a. In the present embodiment, the optical axis of the angle conversion member 38 coincides with the first optical axis J1.

The second light L2 made incident on the angle conversion member 38 changes the traveling direction to approach the direction parallel to the first optical axis J1 every time the second light L2 is totally reflected on the reflection side surface 38c. Accordingly, the angle conversion member 38 converts an emission angle distribution of the second light L2 emitted from the wavelength conversion member 30. More specifically, the angle conversion member 38 makes a maximum emission angle of the second light L2 on the emission surface 38b smaller than a maximum incident angle of the second light L2 on the incident surface 38a.

In general, since the etendue of light defined by a product of the area of a light emission region and the maximum exit angle, which is a solid angle of light, is preserved, the etendue of the second light L2 is preserved even before and after being transmitted through the angle conversion member 38. As explained above, the angle conversion member 38 has a configuration in which the area of the emission surface 38b is made larger than the area of the incident surface 38a. For this reason, from the viewpoint of the etendue preservation, the angle conversion member 38 can make the maximum exit angle of the second light L2 on the emission surface 38b smaller than the maximum incident angle of the second light L2 on the incident surface 38a.

The angle conversion member 38 is fixed to the wavelength conversion member 30 via a not-illustrated optical adhesive such that the incident surface 38a faces the third surface 30c of the wavelength conversion member 30. That is, the angle conversion member 38 and the wavelength conversion member 30 are in contact via the optical adhesive and an air gap such as an air layer is not provided between the angle conversion member 38 and the wavelength conversion member 30. If an air gap is provided between the angle conversion member 38 and the wavelength conversion member 30, in the second light L2 that has reached the incident surface 38a of the angle conversion member 38, the second light L2 made incident on the incident surface 38a at an angle equal to or larger than a critical angle is totally reflected on the incident surface 38a and cannot be made incident on the angle conversion member 38. In contrast, when an air gap is not provided between the angle conversion member 38 and the wavelength conversion member 30 as in the present embodiment, a lost component of the second light L2 that cannot be made incident on the angle conversion member 38 because of the total reflection can be reduced. From this viewpoint, it is desirable to match the refractive index of the angle conversion member 38 and the refractive index of the wavelength conversion member 30 as much as possible.

Note that the configuration of the angle conversion member 38 is not limited to the present embodiment and may be, for example, a compound parabolic concentrator (CPC). Even when the CPC is used as the angle conversion member 38, the same effects as the effect obtained when the tapered rod is used can be obtained. The light source device 21 may not include the angle conversion member 38.

The integrator optical system 50 includes a first lens array 52 and a second lens array 53. The integrator optical system 50, together with the superimposing optical system 56, functions as a homogenous illumination optical system that homogenizes the intensity distribution of the second light L2 emitted from the light source device 21 in each of the light modulation devices 4R, 4G which are illumination regions. The second light L2 emitted from the emission surface 38b of the angle conversion member 38 is made incident on the first lens array 52.

The first lens array 52 includes a plurality of first small lenses 52a. The first small lenses 52a are arrayed in a matrix on a surface orthogonal to the first optical axis J1. The first small lenses 52a divide the second light L2 emitted from the angle conversion member 38 into a plurality of partial light beams. The shape of the first small lenses 52a is a rectangular shape substantially similar to the shape of image formation regions of each of the light modulation devices 4R and 4G. Accordingly, each of the partial light beams emitted from the first lens array 52 is efficiently made incident on the image formation regions of the light modulation devices 4R and 4G.

The second lens array 53 is disposed at the emission side of the first lens array 52. The second light L2 emitted from the first lens array 52 is made incident on the second lens array 53. The second lens array 53 includes a plurality of second small lenses 53a corresponding to the plurality of first small lenses 52a of the first lens array 52. The second small lenses 53a are arrayed in a matrix on a surface orthogonal to the first optical axis J1. The second lens array 53 forms, in conjunction with the superimposing optical system 56, near the image formation regions of the light modulation devices 4R and 4G, an image of the second light L2 emitted from the first small lenses 52a of the first lens array 52.

The first small lenses 52a of the first lens array 52 and the second small lenses 53a of the second lens array 53 have the same size in the present embodiment but may have sizes different from each other. The first small lens 52a of the first lens array 52 and the second small lens 53a of the second lens array 53 are disposed at positions where the optical axes thereof coincide with each other in the present embodiment but may be disposed at positions where the optical axes thereof are eccentric.

The polarization conversion element 55 includes a not illustrated polarization separation layer that directly transmits one linearly polarized light component among polarization components included in the second light L2 emitted from the light source device 21 and reflects the other linearly polarized light component in a direction perpendicular to the first optical axis J1, a not-illustrated reflecting layer that reflects the other linearly polarized light component reflected by the polarization separation layer in a direction parallel to the first optical axis J1, and a not illustrated retarder that converts the other linearly polarized light component reflected by the reflecting layer into the one linearly polarized light component. The polarization conversion element 55 converts a polarization direction of the second light L2 emitted from the second lens array 53. More specifically, the polarization conversion element 55 converts the partial light beams of the second light L2 divided by the first lens array 52 and emitted from the second lens array 53 into linearly polarized light.

The second light L2 transmitted through the polarization conversion element 55 is made incident on the superimposing optical system 56. The superimposing optical system 56 configures, in cooperation with the integrator optical system 50, a homogenous illumination optical system that homogenizes the intensity distribution of the second light L2 in each of the light modulation devices 4R and 4G, which are the illumination regions. The superimposing optical system 56 makes the second light L2 incident on the color separation optical system 3.

The pressing member 61 illustrated in FIG. 5 presses the wavelength conversion member 30, that is, the light guide member against the support surface 43. The pressing member 61 is a leaf spring extending in the Z-axis direction. The pressing member 61 has elasticity. As illustrated in FIG. 3, the light source device 21 includes a plurality of pressing members 61. In the present embodiment, the light source device 21 includes two pressing members 61. The pressing members 61 are disposed on the inside of the recesses 49a different from each other. The pressing members 61 are disposed spaced apart from each other in the longitudinal direction (the X-axis direction). The plurality of pressing members 61 are respectively fixed to the fixed sections 49c different from each other. More specifically, one pressing member 61 is fixed to the first fixed section 49d and the other pressing member 61 is fixed to the second fixed section 49e.

As illustrated in FIG. 5, elastic members 62 elastically deformable in the incident direction (the Y-axis direction) are disposed between one end of the pressing member 61 and the fixed section 49c and between the other end of the pressing member 61 and the fixed section 49c. In the present embodiment, the elastic members 62 are coil springs. When a screw 63 is inserted into each of the hole section at one end of the pressing member 61 and the hole section at the other end of the pressing member 61 and tightened into the hole section 49g, an elastic force facing the −Y side is applied to the pressing member 61 by the elastic member 62. Accordingly, the position of the pressing member 61 in the incident direction is determined and the pressing member 61 is fixed to the fixed section 49c. The center of the pressing member 61 in the Z-axis direction presses the first surface 30a of the wavelength conversion member 30 from the −Y side. More specifically, the pressing member 61 applies a pressing force Fp facing the +Y side to the wavelength conversion member 30 to thereby press the second surface 30b of the wavelength conversion member 30 against the support surface 43. Accordingly, the pressing member 61 presses the wavelength conversion member 30 against the support surface 43.

As explained above, the plurality of pressing members 61 are disposed spaced apart from each other in the longitudinal direction (the X-axis direction). As illustrated in FIG. 6, in the present embodiment, the wavelength conversion member 30 includes a first portion 30h and a second portion 30j. The first portion 30h is, in the wavelength conversion member 30, a portion overlapping the pressing member 61 when viewed from the first direction D1. In the present embodiment, the wavelength conversion member 30 includes two first portions 30h. The first portions 30h are disposed spaced apart in the longitudinal direction. The first portions 30h are pressed against the support surface 43 by the pressing member 61.

The second portion 30j is, in the wavelength conversion member 30, a portion located between the two pressing members 61 in the longitudinal direction (the X-axis direction). In the longitudinal direction, the second portion 30j is located between the two fixed sections 49c. For that reason, a pressing force with which the second portion 30j presses the support surface 43 is smaller than a pressing force with which the first portion 30h presses the support surface 43. Therefore, the thermal resistance between the second portion 30j and the support surface 43 is larger than the thermal resistance between the first portion 30h and the support surface 43.

As illustrated in FIG. 5, the heat transfer member 70 has a columnar shape extending in the second direction D2. In the present embodiment, the heat transfer member 70 has a substantially cylindrical shape extending in the second direction D2. The heat transfer member 70 may have a substantially cylindrical shape extending in the second direction D2. The heat transfer member 70 is disposed on the inside of the housing hole 42k. In the present embodiment, the heat transfer member 70 is made of copper. The thermal conductivity of the heat transfer member 70 is higher than the thermal conductivity of the holding section 42. As illustrated in FIG. 6, the support member 41 includes a plurality of heat transfer members 70. In the present embodiment, the support member 41 includes six heat transfer members 70. The number of heat transfer members 70 provided in the support member 41 may be five or less or may be seven or more. The heat transfer members 70 are disposed on the insides of the housing holes 42k different from one another. That is, the heat transfer members 70 are disposed on the inside of the holding section 42. The plurality of heat transfer members 70 are disposed in the longitudinal direction (the X-axis direction). In the present embodiment, the heat transfer members 70 are fitted in the inner surfaces of the housing holes 42k. Accordingly, the holding section 42 holds the heat transfer members 70. As illustrated in FIG. 5, the outer surfaces of the heat transfer members 70 are in contact with the inner surfaces of the housing holes 42k. The heat transfer members 70 may be fixed to the inner surfaces of the housing holes 42k by an adhesive.

As explained above, the heat transfer member 70 has a substantially cylindrical shape extending in the second direction D2. The thermal conductivity of the heat transfer member 70 is higher than the thermal conductivity of the holding section 42. Accordingly, compared with when the support member 41 does not include the heat transfer member 70, an amount of heat H1 transferred from the center of the support member 41 in the second direction D2 to both the end portions of the support member 41 in the second direction D2 can be increased. For that reason, an amount of heat transferred from the wavelength conversion member 30 to the outer surface facing the second direction D2 of the holding section 42 can be increased. Accordingly, an amount of heat radiated from the outer surface facing the second direction D2 of the holding section 42 to the outside of the light source device 21 can be increased. Therefore, it is possible to increase an amount of heat radiated from the wavelength conversion member 30 to the outside of the light source device 21 via the support member 41. Accordingly, the temperature of the wavelength conversion member 30 can be prevented from excessively rising.

As explained above, when viewed from the first direction D1, parts of the housing holes 42k overlap the wavelength conversion member 30. Therefore, as illustrated in FIG. 3, when viewed from the first direction D1, a portion of each heat transfer member 70 on the center side in the second direction D2 overlaps the wavelength conversion member 30. That is, when viewed from the first direction D1, at least a portion of the heat transfer member 70 overlaps the wavelength conversion member 30, that is, the light guide member. As illustrated in FIG. 6, when viewed from the first direction D1, the first portion 30h of the wavelength conversion member 30, that is, in the wavelength conversion member 30, a portion pressed by the pressing member 61 overlaps the heat transfer member 70. When viewed from the first direction D1, the first portion 30h of the wavelength conversion member 30 may not overlap the heat transfer member 70. Further, in the present embodiment, among the plurality of heat transfer members 70, each of the heat transfer member 70 disposed third from the +X side and the heat transfer member 70 disposed fourth from the +X side overlaps the second portion 30j of the wavelength conversion member 30 when viewed from the first direction D1. As explained above, the second portion 30j is located between the two fixed sections 49c in the longitudinal direction (the X-axis direction). Accordingly, in the present embodiment, at least a part of the heat transfer member 70 are disposed between the plurality of fixed sections 49c in the longitudinal direction.

According to the present embodiment, the light source device 21 includes the light source unit 34 including the light emitting element 36 that emits the first light L1, that is, light, the wavelength conversion member 30, that is, the light guide member on which the first light L1 emitted from the light emitting element 36 is made incident and that emits the second light L2, that is, light, and the support member 41 that supports the wavelength conversion member 30, the support member 41 includes the support surface 43 that faces the first direction D1 intersecting the longitudinal direction (the X-axis direction), which is the direction in which the wavelength conversion member 30 extends, and supports the wavelength conversion member 30, the heat transfer member 70 that extends in the second direction D2 intersecting the longitudinal direction, and the holding section 42 that holds the heat transfer member 70, the heat transfer member 70 is disposed on the inside of the holding section 42, and the thermal conductivity of the heat transfer member 70 is higher than the thermal conductivity of the holding section 42. As explained above, when the phosphor 33 provided in the wavelength conversion member 30 absorbs the first light L1, the phosphor 33 generates heat. The heat of the wavelength conversion member 30 is transferred to the support member 41 via the support surface 43 and radiated from the outer surface of the support member 41 to the outside of the light source device 21. In contrast, in the present embodiment, as explained above, the amount of the heat transferred from the wavelength conversion member 30 to the outer surface facing the second direction D2 of the holding section 42 by the heat transfer member 70 can be increased. Therefore, since the amount of the heat radiated from the wavelength conversion member 30 to the outside of the light source device 21 via the support member 41 can be increased, the temperature of the wavelength conversion member 30 can be prevented from excessively rising. Since the temperature of the wavelength conversion member 30 can be prevented from excessively rising, temperature quenching of the second light L2 in the wavelength conversion member 30 can be reduced. Therefore, the wavelength conversion efficiency of the wavelength conversion member 30 can be increased.

In the present embodiment, compared with when the support member 41 does not include the heat transfer member 70, since an amount of heat transferred from the support surface 43 to the outer surface facing the second direction D2 of the holding section 42 can be increased, the temperature of the support surface 43 can be reduced. Accordingly, since the temperature difference between the wavelength conversion member 30 and the support surface 43 can be increased, an amount of heat transferred from the wavelength conversion member 30 to the holding section 42 via the support surface 43 can be increased. Therefore, the temperature of the wavelength conversion member 30 can be more suitably prevented from excessively rising.

According to the present embodiment, the second direction D2 is a direction intersecting both of the longitudinal direction (the X-axis direction) and the first direction D1. For that reason, the amount of the heat transferred from the wavelength conversion member 30 to the outer surface facing the second direction D2 of the holding section 42 by the heat transfer member 70 can be increased. Accordingly, the amount of the heat radiated from the wavelength conversion member 30 to the outside of the light source device 21 via the support member 41 can be increased. Therefore, the temperature of the wavelength conversion member 30 can be prevented from excessively rising.

According to the present embodiment, when viewed from the first direction D1, at least a part of the heat transfer member 70 overlaps the wavelength conversion member 30, that is, the light guide member. Thus, the distance between the heat transfer member 70 and the wavelength conversion member 30 can be reduced compared with when the heat transfer member 70 does not overlap the wavelength conversion member 30 when viewed from the first direction D1. For that reason, the thermal resistance between the heat transfer member 70 and the wavelength conversion member 30 can be reduced. Accordingly, the amount of the heat transferred from the wavelength conversion member 30 to the outer surface of the holding section 42 by the heat transfer member 70 can be more suitably increased. Therefore, the temperature of the wavelength conversion member 30 can be more suitably prevented from excessively rising.

According to the present embodiment, the heat transfer member 70 has a columnar or tubular shape extending in the second direction D2. For that reason, the amount of the heat transferred from the wavelength conversion member 30 to the outer surface facing the second direction D2 of the holding section 42 by the heat transfer member 70 can be increased. Accordingly, the amount of the heat radiated from the wavelength conversion member 30 to the outside of the light source device 21 via the support member 41 can be increased. Therefore, the temperature of the wavelength conversion member 30 can be prevented from excessively rising.

According to the present embodiment, the support member 41 includes the plurality of heat transfer members 70 and the plurality of heat transfer members 70 are disposed in the longitudinal direction (the Z-axis direction). Therefore, temperature variation of the wavelength conversion member 30 in the longitudinal direction is easily reduced. Accordingly, in the longitudinal direction, the temperature of a part of the wavelength conversion member 30 can be suitably prevented from excessively rising, the temperature of the entire wavelength conversion member 30 can be more suitably reduced. Therefore, since the temperature quenching of the second light L2 can be reduced in the entire wavelength conversion member 30, the wavelength conversion efficiency of the wavelength conversion member 30 can be more suitably increased.

According to the present embodiment, the light source device 21 includes the pressing member 61 that presses the wavelength conversion member 30, that is, the light guide member against the support surface 43 and, when viewed from the first direction D1, the first portion 30h, that is, in the wavelength conversion member 30, the portion pressed by the pressing member 61 overlaps the heat transfer member 70. Since the first portion 30h is pressed against the support surface 43 by the pressing member 61, the thermal resistance between the first portion 30h and the support surface 43 is small. In the present embodiment, as explained above, the first portion 30h overlaps the heat transfer member 70 when viewed from the first direction D1. Accordingly, the thermal resistance between the first portion 30h and the heat transfer member 70 can be reduced. For that reason, in the present embodiment, an amount of heat transferred from the wavelength conversion member 30 to the heat transfer member 70 can be more suitably increased. Accordingly, the amount of the heat radiated from the wavelength conversion member 30 to the outside of the light source device 21 via the support member 41 can be more suitably increased. Therefore, the temperature of the wavelength conversion member 30 can be more suitably prevented from excessively rising.

According to the present embodiment, the light source device 21 includes the plurality of pressing members 61 disposed spaced apart from one another in the longitudinal direction (the X-axis direction), the support member 41 includes the plurality of fixed sections 49c disposed spaced apart from one another in the longitudinal direction, the plurality of pressing members 61 are respectively fixed to the fixed sections 49c different from one another, and at least a part of the heat transfer member 70 are disposed between the plurality of fixed sections 49c in the longitudinal direction. As explained above, the thermal resistance between the second portion 30j, which is, in the wavelength conversion member 30, a portion between the plurality of fixed sections 49c, and the support surface 43 is larger than the thermal resistance between the first portion 30h and the support surface 43. Therefore, when the heat transfer member 70 is not disposed between the plurality of fixed sections 49c in the longitudinal direction, since an amount of heat transferred from the second portion 30j to the holding section 42 tends to be small, the temperature of the second portion 30j tends to be high. In contrast, in the present embodiment, since at least a part of the heat transfer member 70 is disposed between the plurality of fixed sections 49c in the longitudinal direction, an amount of heat transferred from, in the support surface 43, a portion in contact with the second portion 30j to the outer surface facing the second direction D2 of the holding section 42 can be increased. Accordingly, since the temperature difference between the second portion 30j and the support surface 43 can be increased, the amount of the heat transferred from the second portion 30j to the holding section 42 can be increased. Therefore, the temperature of the second portion 30j of the wavelength conversion member 30 can be more suitably prevented from excessively rising.

According to the present embodiment, in the wavelength conversion member 30, the light emitting elements 36 emit the first light L1 having the first wavelength band and the light guide member includes the phosphor 33, converts the first light L1 into the second light L2 having the second wavelength band different from the first wavelength band, and emits the second light L2. As explained above, in the present embodiment, the temperature of the wavelength conversion member 30 can be prevented from excessively rising. Therefore, since the temperature quenching of the second light L2 in the wavelength conversion member 30 can be reduced, the wavelength conversion efficiency of the wavelength conversion member 30 can be prevented from decreasing.

According to the present embodiment, the projector 1 includes the light source device 21, the light modulation devices 4R, 4G, and 4B that modulate light emitted from the light source device 21, and the projection optical device 6 that projects the light modulated by the light modulation devices 4R, 4G, and 4B. As explained above, in the present embodiment, since the wavelength conversion efficiency in the wavelength conversion member 30 can be increased, an amount of the second light L2 emitted from the wavelength conversion member 30 can be increased. Accordingly, an amount of the first light L1 necessary for causing the wavelength conversion member 30 to emit a predetermined amount of the second light L2 can be reduced. Therefore, since the amount of the first light L1 emitted by the light emitting elements 36 can be reduced, electric power consumed by the projector 1 can be suppressed.

### Second Embodiment

A projector 201 in a second embodiment is explained below.

A basic configuration of the projector 201 in the present embodiment is the same as the configuration of the projector 1 in the first embodiment. In the projector 201 in the present embodiment, the heat transfer member 270 is a cylindrical heat pipe extending in the second direction D2. In the following explanation, elements in the same aspect as the aspect of the projector 1 in the first embodiment explained above are denoted by the same reference numerals and signs and explanation of the elements is omitted.

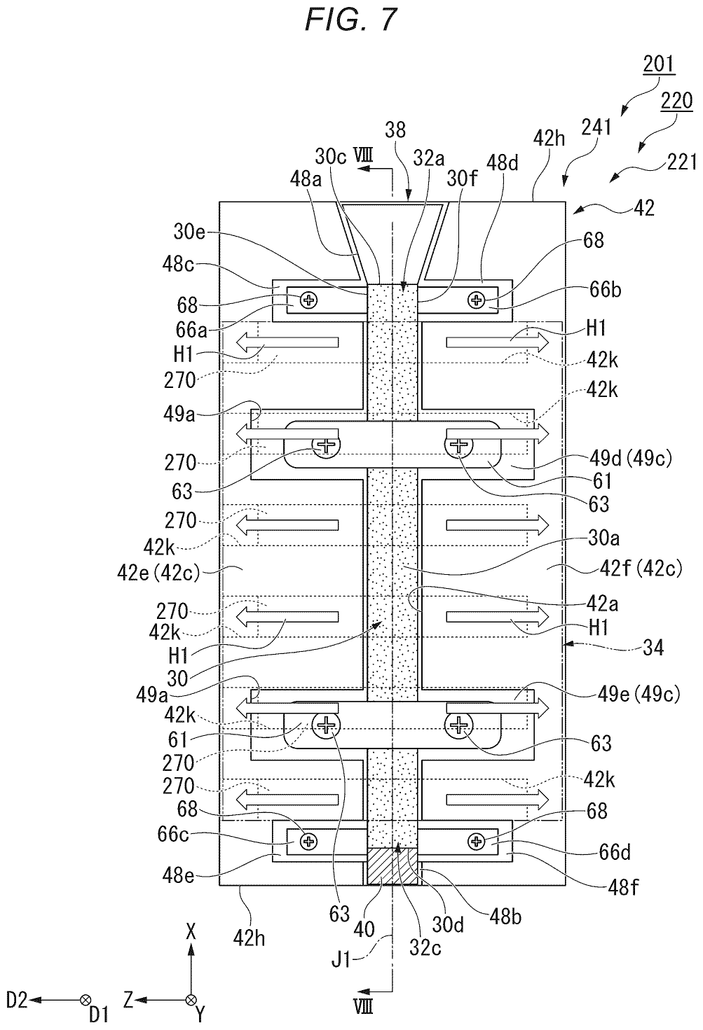

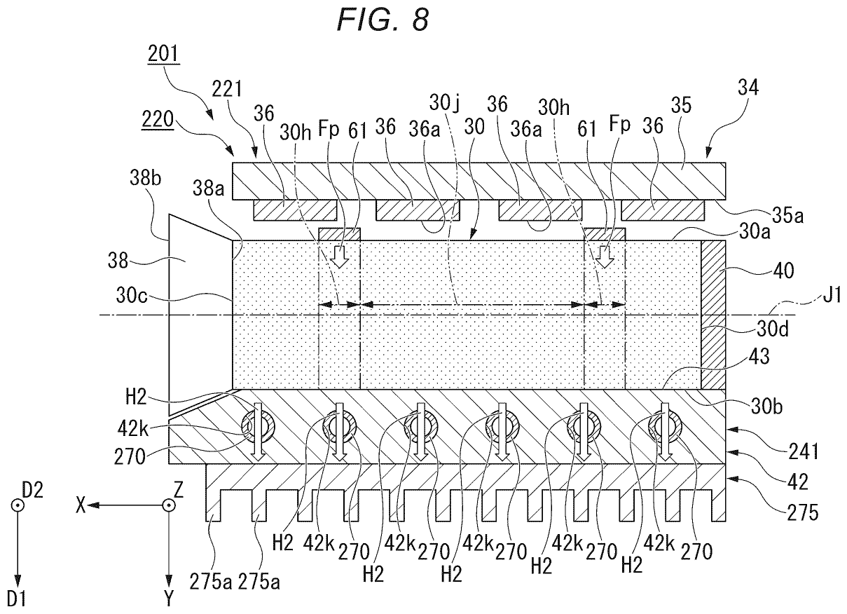

FIG. 7 is a plan view of the light source device 221 in the present embodiment viewed from the first direction D1. FIG. 8 is a cross-sectional view of the light source device 221 taken along a VIII-VIII line in FIG. 7. As illustrated in FIG. 8, the light source device 221 provided in a first illumination device 220 includes the wavelength conversion member 30, the light source unit 34, the angle conversion member 38, the mirror 40, a support member 241, the pressing member 61, and a heat sink 275.

The support member 241 supports the wavelength conversion member 30. The heat generated in the wavelength conversion member 30 is transferred to the support member 241. The heat is radiated to the outside of the light source device 221. The support member 241 includes the holding section 42 and a heat transfer member 270. A configuration and the like of the holding section 42 in the present embodiment are the same as the configuration and the like of the holding section 42 in the first embodiment explained above.

As illustrated in FIG. 7, the heat transfer member 270 extends in the second direction D2. As illustrated in FIG. 8, the heat transfer member 270 in the present embodiment is a tubular heat pipe. The thermal conductivity of the heat transfer member 270 in the present embodiment is higher than the thermal conductivity of the heat transfer member 70 in the first embodiment explained above. The thermal conductivity of the heat transfer member 270 is higher than the thermal conductivity of the holding section 42. The heat transfer member 270 is disposed on the inside of the housing hole 42k. In the heat transfer member 270, not-illustrated hydraulic fluid is stored on the inside of a cylindrical pipe extending in the second direction D2. As a material of the pipe, a metal material such as copper and aluminum can be used. In the present embodiment, the pipe is made of copper. As the hydraulic fluid, liquid such as water or ethanol can be used. In the present embodiment, the hydraulic fluid is ethanol. The hydraulic fluid absorbs the heat of the holding section 42 and vaporizes in the center in the second direction D2 and transfers the heat to the holding section 42 and condenses in portions on both sides in the second direction D2. Accordingly, an amount of heat H1 (see FIG. 7) transferred from the center of the support member 241 in the second direction D2 to both end portions of the support member 241 in the second direction D2 can be increased. For that reason, an amount of heat transferred from the wavelength conversion member 30 to the outer surface facing the second direction D2 of the holding section 42 can be increased. As illustrated in FIG. 8, the hydraulic fluid absorbs the heat of a portion on a −D1 side of the holding section 42, that is, on the wavelength conversion member 30 side and vaporizes and transfers the heat to a portion on a +D1 side of the holding section 42, that is, on the heat sink 275 side and condenses. Accordingly, an amount of heat H2 transferred from a portion on the −D1 side to a portion on the +D1 side of the support member 241 can be increased. For that reason, an amount of heat transferred from the wavelength conversion member 30 to the heat sink 275 can be increased. Accordingly, an amount of heat radiated from the wavelength conversion member 30 to the outside of the light source device 221 via the support member 241 can be increased.

The support member 241 includes a plurality of heat transfer members 270. In the present embodiment, the support member 241 includes six heat transfer members 270. The heat transfer members 270 are disposed on the insides of the housing holes 42k different from one another. The holding section 42 holds the heat transfer members 270.

As illustrated in FIG. 7, at least a part of the heat transfer member 270 overlaps the wavelength conversion member 30 when viewed from the first direction D1. As illustrated in FIG. 8, when viewed from the first direction D1, the first portion 30h of the wavelength conversion member 30, that is, a portion of the wavelength conversion member 30 pressed by the pressing member 61 overlaps the heat transfer member 270. Further, in the present embodiment, among the plurality of heat transfer members 270, each of the heat transfer member 270 disposed third from the +X side and the heat transfer member 270 disposed fourth from the +X side overlaps the second portion 30j of the wavelength conversion member 30 when viewed from the first direction D1. That is, in the longitudinal direction (the X-axis direction), at least a part of the heat transfer member 270 is disposed between the plurality of fixed sections 49c. Other components and the like of the support member 241 in the present embodiment are the same as the other components of the support member 41 in the first embodiment explained above.

In the present embodiment, the heat transfer members 270 are disposed spaced apart in the longitudinal direction (the X-axis direction). However, the heat transfer members 270 may be coupled to one another. In this case, a pipe provided in a heat transfer member includes a plurality of portions extending in the second direction D2 and disposed spaced apart in the longitudinal direction and a portion extending in the first direction D1 for connecting the portions extending in the second direction D2.

The heat sink 275 is attached to a surface facing the +D1 side of the holding section 42. That is, the heat sink 275 is attached to a surface facing the side opposite to the support surface 43 among the outer surfaces of the holding section 42. The heat sink 275 is made of metal. In the present embodiment, the heat sink 275 is made of aluminum. The thermal conductivity of the heat sink 275 is preferably higher than the thermal conductivity of the holding section 42. The heat sink 275 includes a plurality of heat radiation fins 275a.

The heat radiation fins 275a protrude to the +D1 side. Although not illustrated, the heat radiation fins 275a have a plate shape extending in the Z-axis direction. The heat radiation fins 275a are disposed spaced apart from one another in the longitudinal direction (the X-axis direction). Note that the heat radiation fins 275a may have a plate shape extending in the longitudinal direction. In this case, the heat radiation fins 275a are disposed spaced apart in the Z-axis direction. In the present embodiment, since the heat sink 275 includes the plurality of heat radiation fins 275a, the surface area of the heat sink 275 can be increased. Accordingly, an amount of heat radiated from the support member 241 to the outside of the light source device 221 via the heat sink 275 can be increased. Therefore, the amount of the heat radiated from the wavelength conversion member 30 to the outside of the light source device 221 via the support member 241 and the heat sink 275 can be increased. Other components and the like of the light source device 221 in the present embodiment are the same as the other components and the like of the light source device 21 in the first embodiment explained above.

According to the present embodiment, the heat transfer member 270 is a tubular heat pipe extending in the second direction D2. Thus, as explained above, the amount of the heat H1 transferred from the center of the support member 241 in the second direction D2 to both the end portions of the support member 241 in the second direction D2 can be increased. For that reason, the amount of the heat transferred from the wavelength conversion member 30 to the outer surface facing the second direction D2 of the holding section 42 by the heat transfer member 270 can be increased. Therefore, since the amount of the heat radiated from the wavelength conversion member 30 to the outside of the light source device 221 via the support member 241 can be increased, the temperature of the wavelength conversion member 30 can be prevented from excessively rising.

According to the present embodiment, the light source device 221 includes the heat sink 275 attached to the surface facing the side opposite to the support surface 43 among the outer surfaces of the holding section 42. Thus, as explained above, the amount of the heat radiated from the support member 241 to the outside of the light source device 221 via the heat sink 275 can be increased. Therefore, since the amount of the heat radiated from the wavelength conversion member 30 to the outside of the light source device 221 via the support member 241 and the heat sink 275 can be increased, the temperature of the wavelength conversion member 30 can be more suitably prevented from excessively rising.

In the present embodiment, as explained above, the amount of the heat H2 transferred from the portion on the −D1 side to the portion on the +D1 side of the support member 241 by the heat transfer member 270 can be increased. Therefore, the amount of the heat transferred from the wavelength conversion member 30 to the heat sink 275 via the support member 241 can be increased. Therefore, since the amount of the heat radiated from the wavelength conversion member 30 to the outside of the light source device 221 via the support member 241 and the heat sink 275 can be more suitably increased, the temperature of the wavelength conversion member 30 can be more suitably prevented from excessively rising.

### Third Embodiment

A projector 301 in a third embodiment is explained below.

A basic configuration of the projector 301 in the present embodiment is the same as the basic configuration of the projector 201 in the second embodiment. In the present embodiment, the second direction D2 is a direction inclined to the first direction D1 from the longitudinal direction (the X-axis direction). In the present embodiment, the second direction D2 is parallel to the first direction D1. The second direction D2 may not be parallel to the first direction D1. In the following explanation, elements in substantially the same aspect as the aspect of the projector 201 in the second embodiment explained above are denoted by the same reference numerals and signs and explanation of the elements is omitted.

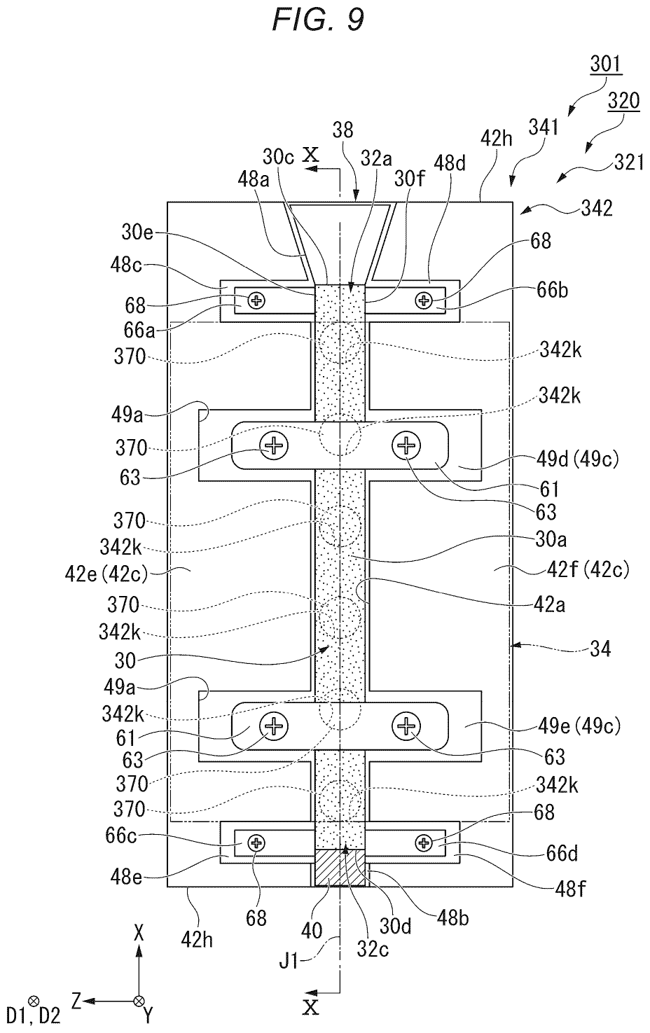

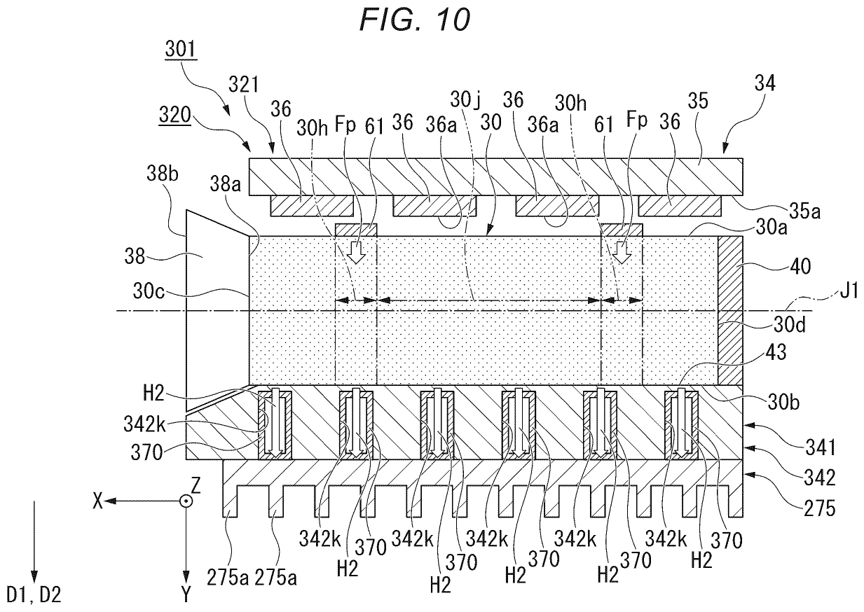

FIG. 9 is a plan view of a light source device 321 in the present embodiment viewed from the first direction D1. FIG. 10 is a cross-sectional view of the light source device 321 taken along a X-X line in FIG. 9. As illustrated in FIG. 10, the light source device 321 provided in the first illumination device 320 includes the wavelength conversion member 30, the light source unit 34, the angle conversion member 38, the mirror 40, a support member 341, the pressing member 61, and the heat sink 275.

The support member 341 supports the wavelength conversion member 30. Heat generated in the wavelength conversion member 30 is transferred to the support member 341. The heat is radiated to the outside of the light source device 321. The support member 341 includes a holding section 342 and a heat transfer member 370.

The holding section 342 extends in the longitudinal direction (the X-axis direction) and holds the wavelength conversion member 30. Heat generated in the wavelength conversion member 30 is transferred to the holding section 342. The heat is radiated from the outer surface of the holding section 342 to the outside of the light source device 21. The holding section 342 includes a housing hole 342k.

The housing hole 342k is a hole recessed to the −D2 side from the surface facing the +D2 side of the holding section 342. That is, the housing hole 342k is a hole extending in the second direction D2. The housing hole 342k is provided further on the +D1 side than the support groove 42a. As illustrated in FIG. 9, the housing hole 342k has a substantially circular shape when viewed from the second direction D2. As illustrated in FIG. 10, the heat transfer member 370 is housed on the inside of the housing hole 342k. The holding section 342 includes a plurality of housing holes 342k. In the present embodiment, the holding section 342 includes six housing holes 342k. As illustrated in FIG. 9, the housing holes 342k are provided spaced apart from each in the longitudinal direction (the X-axis direction). When viewed from the first direction D1, the housing holes 342k overlaps the wavelength conversion member 30. Other components and the like of the holding section 342 in the present embodiment are the same as the other components and the like of the holding section 42 in the second embodiment explained above.

As illustrated in FIG. 10, the heat transfer member 370 is a cylindrical heat pipe extending in the second direction D2. The thermal conductivity of the heat transfer member 370 is higher than the thermal conductivity of the holding section 342. The heat transfer member 370 is disposed on the inside of the housing hole 342k. In the heat transfer member 370, not illustrated hydraulic fluid is housed on the inside of a cylindrical pipe extending in the second direction D2. The hydraulic fluid absorbs the heat in a portion on the −D1 side of the holding section 342, that is, on the wavelength conversion member 30 side and vaporizes and transmits the heat to a portion on the +D1 side of the holding section 342, that is, on the heat sink 275 side and condenses. As a result, an amount of the heat H2 transferred from the portion on the −D1 side to the portion on the +D1 side of the support member 341 can be increased. For that reason, an amount of heat transferred from the wavelength conversion member 30 to the outer surface facing the +D1 side of the holding section 342 can be increased. Therefore, an amount of heat radiated from the wavelength conversion member 30 to the outside of the light source device 321 via the support member 341 can be increased. In the present embodiment, since the amount of the heat H2 transferred from the portion on the −D1 side to the portion on the +D1 side of the support member 341 can be increased, the amount of the heat transferred from the wavelength conversion member 30 to the heat sink 275 can be increased. Accordingly, an amount of heat radiated from the wavelength conversion member 30 to the outside of the light source device 321 via the support member 341 can be increased.

The support member 341 includes a plurality of heat transfer members 370. In the present embodiment, the support member 341 includes six heat transfer members 370. The heat transfer members 370 are disposed on the insides of the housing holes 342k different from one another. The holding section 342 holds the heat transfer members 370.

As illustrated in FIG. 9, at least a part of the heat transfer member 370 overlaps the wavelength conversion member 30 when viewed from the first direction D1. As illustrated in FIG. 10, when viewed from the first direction D1, the first portion 30h of the wavelength conversion member 30, that is, in the wavelength conversion member 30, a portion pressed by the pressing member 61 overlaps the heat transfer member 370. Further, in the present embodiment, among the plurality of heat transfer members 370, each of the heat transfer member 370 disposed third from the +X side and the heat transfer member 370 disposed fourth from the +X side overlaps the second portion 30j of the wavelength conversion member 30 when viewed from the first direction D1. That is, in the longitudinal direction (the X-axis direction), at least a part of the heat transfer member 370 is disposed between the plurality of fixed sections 49c. Other components and the like of the support member 341 in the present embodiment are the same as the other components and the like of the support member 241 in the second embodiment explained above. Other components and the like of the light source device 321 in the present embodiment are substantially the same as the other components and the like of the light source device 221 in the second embodiment explained above.

According to the present embodiment, the second direction D2 is a direction inclined to the first direction D1 from the longitudinal direction (the X-axis direction). Therefore, as explained above, the amount of the heat H2 transferred from the portion on the −D1 side to the portion on the +D1 side of the support member 341 by the heat transfer member 370 can be increased. Accordingly, the amount of the heat transferred from the wavelength conversion member 30 to the outer surface facing the +D1 side of the holding section 342 can be increased. Therefore, since the amount of the heat radiated from the wavelength conversion member 30 to the outside of the light source device 321 via the support member 341 can be increased, the temperature of the wavelength conversion member 30 can be prevented from excessively rising.

In the present embodiment, as explained above, the amount of the heat transferred from the wavelength conversion member 30 to the heat sink 275 by the heat transfer member 370 can be increased. Accordingly, the amount of the heat radiated from the wavelength conversion member 30 to the outside of the light source device 321 can be more suitably increased. Therefore, the temperature of the wavelength conversion member 30 can be more suitably prevented from excessively rising.

### Fourth Embodiment

A projector 401 in a fourth embodiment is explained below.

A basic configuration of the projector 401 in the present embodiment is the same as the basic configuration of the projector 1 in the first embodiment. In the present embodiment, the heat transfer member 470 is a plate-shaped vapor chamber spreading first direction D1. In the following explanation, elements in the same aspect as the aspect of the projector 1 in the first embodiment explained above are denoted by the same reference numerals and signs and explanation of the elements is omitted.

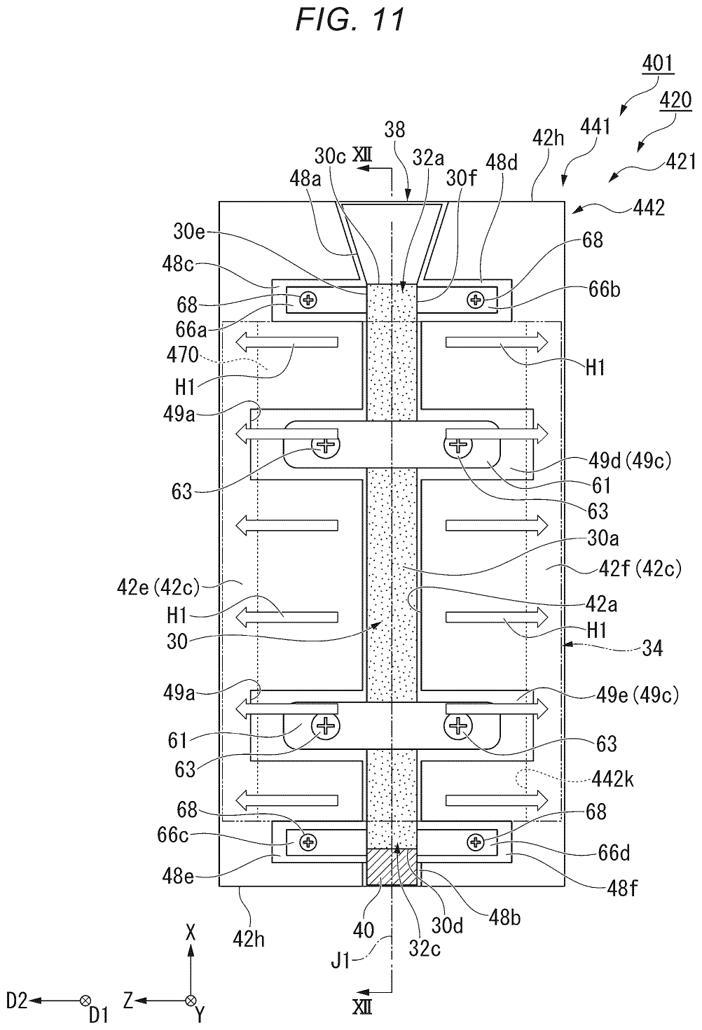

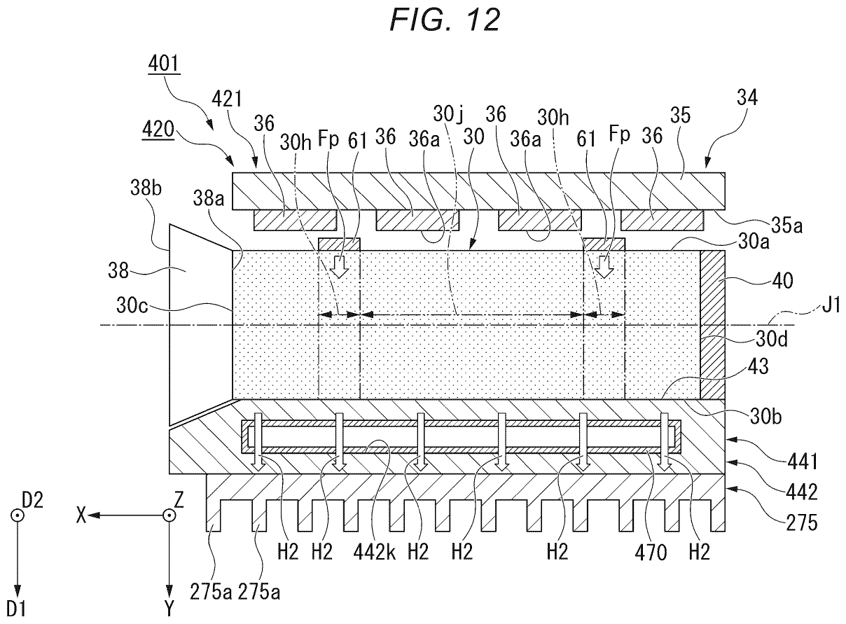

FIG. 11 is a plan view of the light source device 421 in the present embodiment viewed from the first direction D1. FIG. 12 is a cross-sectional view of the light source device taken along a III-III line in FIG. 11. As illustrated in FIG. 12, the light source device 421 provided in a first illumination device 420 includes the wavelength conversion member 30, the light source unit 34, the angle conversion member 38, the mirror 40, a support member 441, the pressing member 61, and the heat sink 275.

The support member 441 supports the wavelength conversion member 30. Heat generated in the wavelength conversion member 30 is transferred to the support member 441. The heat is radiated to the outside of the light source device 421. The support member 441 includes a holding section 442 and a heat transfer member 470.

The holding section 442 extends in the longitudinal direction (the X-axis direction) and holds the wavelength conversion member 30. Heat generated in the wavelength conversion member 30 is transferred to the holding section 442. The heat is radiated from the outer surface of the holding section 442 to the outside of the light source device 21. The holding section 442 includes a housing hole 442k.

As illustrated in FIG. 11, the housing hole 442k is a hole recessed from the surface facing the +D2 side of the holding section 442 to the −D2 side. The housing hole 442k is a hole extending in a direction orthogonal to the first direction D1. When viewed from the first direction D1, the housing hole 442k has a substantially rectangular shape, long sides of which extend in a major axis direction (the X-axis direction). As illustrated in FIG. 12, when viewed from the second direction D2, the housing hole 442k has a substantially rectangular shape, long sides of which extend in the longitudinal direction. As illustrated in FIG. 11, in the longitudinal direction, the end portion on the +X side of the housing hole 442k is at substantially the same position as the end portion on the +X side of the support groove 42a. In the longitudinal direction, the end portion on the −X side of the housing hole 442k is at substantially the same position as the end portion on the −X side of the support groove 42a. In the second direction D2, the end portion on the −D2 side of the housing hole 442k is at substantially the same position as an end portion on the −D2 side of the recess 49a. The housing hole 442k overlaps the wavelength conversion member 30 when viewed from the first direction D1. As illustrated in FIG. 12, the housing hole 442k is provided further on the +D1 side than the support groove 42a. The heat transfer member 470 is housed on the inside of the housing hole 442k. Other components and the like of the holding section 442 in the present embodiment are the same as other components and the like of the holding section 42 in the first embodiment explained above.

As illustrated in FIGS. 11 and 12, the heat transfer member 470 in the present embodiment is a plate-shaped vapor chamber spreading in a direction intersecting the first direction D1. The thermal conductivity of the heat transfer member 470 is higher than the thermal conductivity of the holding section 442. In the present embodiment, the heat transfer member 470 has a plate shape spreading in a direction orthogonal to the first direction D1. A plate surface of the heat transfer member 470 faces the first direction D1. The plate surface of the heat transfer member 470 may face a direction inclined from the first direction D1. The heat transfer member 470 is disposed on the inside of the housing hole 442k. The holding section 442 holds the heat transfer member 470. In the heat transfer member 470, not illustrated hydraulic fluid is stored on the inside of a hollow plate-shaped chamber extending in a direction orthogonal to the first direction D1. The hydraulic fluid absorbs the heat of the holding section 442 and vaporizes in the center in the second direction D2 and transfers the heat to the holding section 442 and condenses in the portions on both sides in the second direction D2. Accordingly, as illustrated in FIG. 11, the amount of the heat H1 transferred from the center of the support member 441 in the second direction D2 to both end portions of the support member 441 in the second direction D2 can be increased. For that reason, an amount of heat transferred from the wavelength conversion member 30 to the outer surface facing the second direction D2 of the holding section 442 can be increased. As illustrated in FIG. 12, the hydraulic fluid absorbs the heat of the portion on the −D1 side of the holding section 442 and vaporizes and transfers the heat to the portion on the +D1 side of the holding section 442 and condenses. Accordingly, the amount of the heat H2 transferred from the portion on the −D1 side to the portion on the +D1 side of the support member 441 can be increased. For that reason, an amount of heat transferred from the wavelength conversion member 30 to the heat sink 275 can be increased. Accordingly, an amount of heat radiated from the wavelength conversion member 30 to the outside of the light source device 421 via the support member 441 can be increased.

The housing hole 442k may be open to the +D1 side. In this case, the heat sink 275 can be attached to the surface facing the +D1 side of the heat transfer member 470. Accordingly, the thermal resistance between the heat transfer member 470 and the heat sink 275 can be reduced. Therefore, the amount of the heat transferred from the wavelength conversion member 30 to the heat sink 275 can be more suitably increased.

As illustrated in FIG. 11, at least a part of the heat transfer member 470 overlaps the wavelength conversion member 30 when viewed from the first direction D1. As illustrated in FIG. 12, when viewed from the first direction D1, the first portion 30h of the wavelength conversion member 30, that is, in the wavelength conversion member 30, the portion pressed by the pressing member 61 overlaps the heat transfer member 470. Further, in the present embodiment, the heat transfer member 470 overlaps the second portion 30j of the wavelength conversion member 30 when viewed from the first direction D1. That is, in the longitudinal direction (the X-axis direction), at least parts of the heat transfer member 470 are disposed among the plurality of fixed sections 49c. Other components and the like of the support member 441 in the present embodiment are the same as the other components and the like of the support member 41 in the first embodiment explained above. Other components and the like of the light source device 421 in the present embodiment are substantially the same as the other components and the like of the light source device 21 according to the first embodiment explained above.

According to the present embodiment, the heat transfer member 470 is a plate-shaped chamber spreading in a direction intersecting the first direction D1. Therefore, as explained above, the amount of the heat H1 transferred from the center of the support member 441 in the second direction D2 to both the end portions of the support member 441 in the second direction D2 by the heat transfer member 470 can be increased. For that reason, an amount of heat transferred from the wavelength conversion member 30 to the outer surface facing the second direction D2 of the holding section 442 can be increased. Therefore, since the amount of the heat radiated from the wavelength conversion member 30 to the outside of the light source device 421 via the support member 441 can be increased, the temperature of the wavelength conversion member 30 can be prevented from excessively rising.

In the present embodiment, since the heat transfer member 470 has a plate shape extending in the longitudinal direction (the X-axis direction), it is easy to suppress temperature variation of the support surface 43 in the longitudinal direction. Therefore, variation in an amount of heat transferred from the wavelength conversion member 30 to the support member 441 in the longitudinal direction can be suitably suppressed. For that reason, temperature variation of the wavelength conversion member 30 in the longitudinal direction can be suitably suppressed. Therefore, the temperature of a part of the wavelength conversion member 30 can be more suitably prevented from excessively rising in the longitudinal direction.

### Fifth Embodiment

A projector 501 in a fifth embodiment is explained below.

A basic configuration of the projector 501 in the present embodiment is the same as the basic configuration of the projector 401 according to the fourth embodiment. In the present embodiment, a support surface 543 includes a surface facing the first direction D1 among the outer surfaces of the heat transfer member 470. In the following explanation, elements in the same aspect as the aspect of the projector 401 in the fourth embodiment explained above are denoted by the same reference numerals and signs and explanation of the elements is omitted.

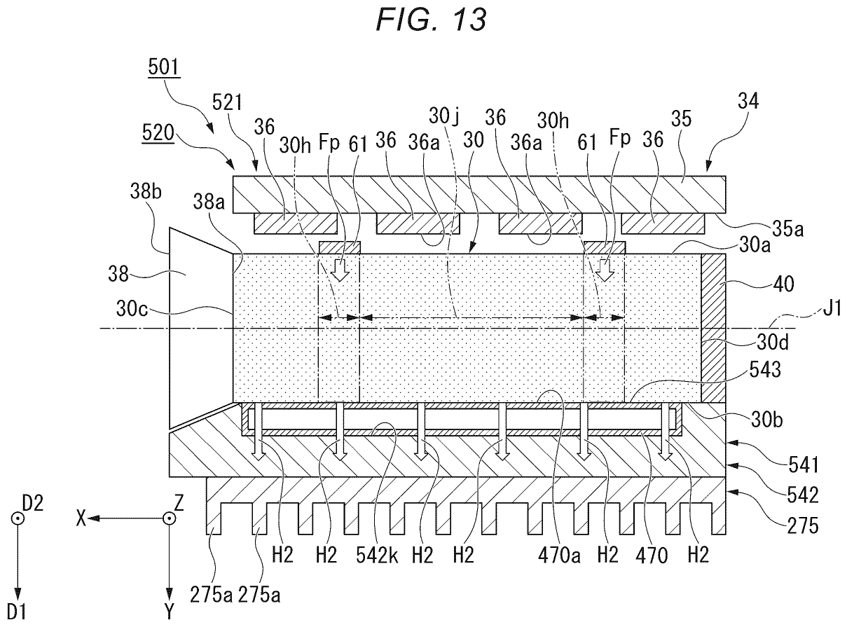

FIG. 13 is a cross-sectional view illustrating the light source device 521 according to the present embodiment. As illustrated in FIG. 13, the light source device 521 provided in a first illumination device 520 includes the wavelength conversion member 30, the light source unit 34, the angle conversion member 38, the mirror 40, a support member 541, the pressing member 61, and the heat sink 275.

The support member 541 supports the wavelength conversion member 30. Heat generated in the wavelength conversion member 30 is transferred to the support member 541. The heat is radiated to the outside of the light source device 521. The support member 541 includes a holding section 542, the heat transfer member 470, and a support surface 543.

The holding section 542 extends in the longitudinal direction (the X-axis direction) and holds the wavelength conversion member 30. The heat generated in the wavelength 30 is transferred to the holding section 542. The heat is radiated from the outer surface of the holding section 542 to the outside of the light source device 21. The holding section 542 includes a housing hole 542k.

The housing hole 542k is a hole recessed to the −D2 side from a surface facing the +D2 side of the holding section 542. The housing hole 442k is a hole extending in a direction orthogonal to the first direction D1. Although not illustrated, when viewed from the first direction D1, the housing hole 542k has a substantially rectangular shape, long sides of which extend in the longitudinal direction (the X-axis direction). The housing hole 542k is provided further on the +D1 side of the support groove 42a. In the present embodiment, the housing hole 542k is opened to the −D1 side. The heat transfer member 470 is housed in the housing hole 542k. Other components and the like of the holding section 542 in the present embodiment are the same as the other components and the like of the holding section 442 in the fourth embodiment explained above.

The heat transfer member 470 in the present embodiment is a plate-shaped vapor chamber spreading in the direction intersecting the first direction D1. A plate surface of the heat transfer member 470 faces the first direction D1.

The support surface 543 is a surface facing the −D1 side among the outer surfaces of the support member 541. The support surface 543 supports the second surface 30b of the wavelength conversion member 30 in the incident direction (the Y-axis direction). In the present embodiment, the support surface 543 includes a surface facing the −D1 side among the inner surfaces of the support groove 42a and a support outer surface 470a that is a surface facing the −D1 side among the outer surfaces of the heat transfer member 470. That is, the support surface 543 includes a surface facing the first direction D1 among the outer surfaces of the heat transfer member 470. The support outer surface 470a is in direct contact with the wavelength conversion member 30. Accordingly, in the present embodiment, since the thermal resistance between the wavelength conversion member 30 and the heat transfer member 470 can be reduced, an amount of heat transferred from the wavelength conversion member 30 to the heat transfer member 470 can be suitably increased. Other components and the like of the support member 541 in the present embodiment are the same as the other components and the like of the support member 441 in the fourth embodiment explained above. Other configurations and the like of the light source device 521 in the present embodiment are the same as the other components and the like of the light source device 421 in the fourth embodiment explained above.

According to the present embodiment, the plate surface of the heat transfer member 470 faces the first direction D1 and the support surface 543 includes the support outer surface 470a, that is, the surface facing the first direction D1 among the outer surfaces of the heat transfer member 470. Thus, as explained above, since the thermal resistance between the wavelength conversion member 30 and the heat transfer member 470 can be reduced, the amount of the heat transferred from the wavelength conversion member 30 to the heat transfer member 470 can be suitably increased. Therefore, since an amount of heat radiated from the wavelength conversion member 30 to the outside of the light source device 521 via the support member 541 can be increased, the temperature of the wavelength conversion member 30 can be suitably prevented from excessively rising.

### Sixth Embodiment

A projector 601 in a sixth embodiment is explained below.

A basic configuration of the projector 601 in the present embodiment is the same as the basic configuration of the projector 201 in the second embodiment. In the projector 601 in the present embodiment, a holding section 642 includes a first holding section 651 and a second holding section 652. In the following explanation, elements in the same aspect as the aspect of the projector 201 in the first embodiment explained above are denoted by the same reference numerals and signs and explanation of the elements is omitted.

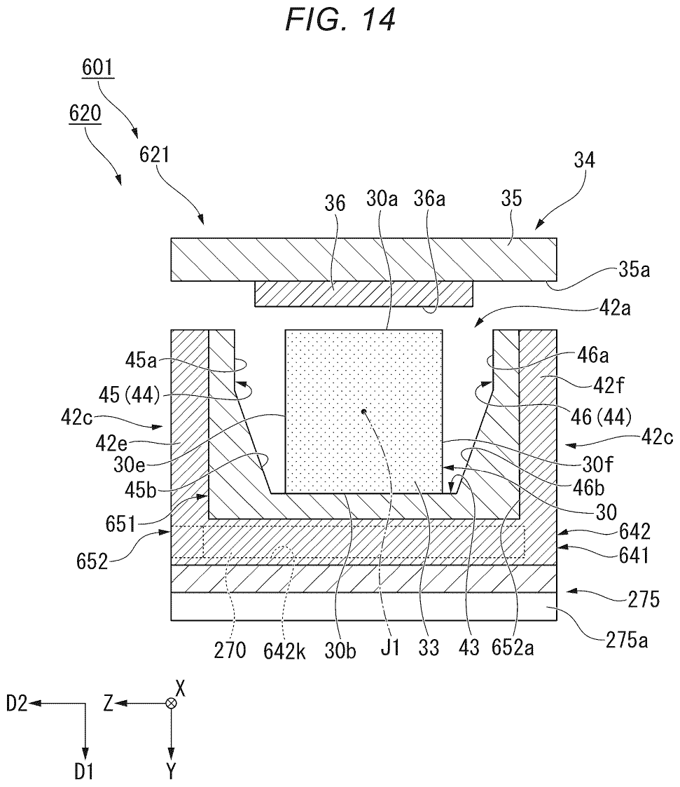

FIG. 14 is a cross-sectional view illustrating a light source device 621 in the present embodiment. As illustrated in FIG. 14, the light source device 621 provided in a first illumination device 620 includes the wavelength conversion member 30, the light source unit 34, the angle conversion member 38 (see FIG. 3), the mirror 40 (see FIG. 3), a support member 641, the pressing member 61 (see FIG. 3), and the heat sink 275.

The support member 641 supports the wavelength conversion member 30. Heat generated in the wavelength conversion member 30 is transferred to the support member 641. The heat is radiated to the outside of the light source device 621. The support member 641 includes the holding section 642 and the heat transfer member 270. The holding section 642 includes the first holding section 651 and the second holding section 652.

The first holding section 651 includes the support surface 43 that supports the wavelength conversion member 30. Each of the dimension in the incident direction (the Y-axis direction) and the dimension in the Z-axis direction of the first holding section 651 is smaller than each of the dimension in the incident direction and the dimension in the Z-axis direction of the holding section 42 in the second embodiment. Other components of the first holding section 651 in the present embodiment are the same as the other components of the holding section 42 in the second embodiment explained above.

The second holding section 652 extends in the longitudinal direction (the X-axis direction). The second holding section 652 holds the first holding section 651. In the present embodiment, the second holding section 652 is made of aluminum. The second holding section 652 has a housing groove 652a and a housing hole 642k.

The housing groove 652a is a groove recessed to the +Y side from a surface facing the −Y side of the second holding section 652. Although not illustrated, the housing groove 652a extends in the longitudinal direction (the X-axis direction). The housing groove 652a has a substantially rectangular shape when viewed in the longitudinal direction. The first holding section 651 is housed on the inside of the housing groove 652a. In the present embodiment, the first holding section 651 is fitted in the inner surface of the housing groove 652a. Accordingly, the second holding section 652 holds the first holding section 651. The first holding section 651 may be fixed to the inner surface of the housing groove 652a by an adhesive.

The housing hole 642k is a hole recessed to the −D2 side from a surface facing the +D2 side of the second holding section 652. That is, the housing hole 642k is a hole extending in the second direction D2. The housing hole 642k is provided further on the +D1 side than the support groove 42a. Although not illustrated, the housing hole 642k has a substantially circular shape when viewed from the second direction D2. Although not illustrated, the second holding section 652 includes six housing holes 642k. The housing holes 642k are provided spaced apart in the longitudinal direction (the X-axis direction). The heat transfer member 270 is housed in the housing holes 642k. Accordingly, the heat transfer member 270 is disposed on the inside of the second holding section 652. Other components and the like of the support member 641 in the present embodiment are the same as the other components and the like of the support member 241 in the second embodiment explained above. Other components and the like of the light source device 621 in the present embodiment are substantially the same as the other components and the like of the light source device 221 in the second embodiment explained above.

According to the present embodiment, the holding section 642 includes the first holding section 651 including the support surface 43 and the second holding section 652 that holds the first holding section 651 and the heat transfer member 270 is disposed on the inside of the second holding section 652. When the heat transfer member 270 is disposed on the inside of the first holding section 651, a hole for housing the heat transfer member 270 needs to be provided in the first holding section 651. When the hole explained above is provided in the first holding section 651 by machining such as cutting, the flatness of the support surface 43 of the first holding section 651 is likely to decrease. When the flatness of the support surface 43 decreases, since the thermal resistance between the wavelength conversion member 30 and the support surface 43 increases, an amount of heat transferred from the wavelength conversion member 30 to the first holding section 651 decreases. In contrast, in the present embodiment, the heat transfer member 270 is disposed on the inside of the second holding section 652. For that reason, the hole for housing the heat transfer member 270 does not need to be provided in the first holding section 651. Therefore, since the flatness of the support surface 43 can be prevented from decreasing, the thermal resistance between the wavelength conversion member 30 and the support surface 43 can be prevented from increasing. Therefore, since the amount of the heat transferred from the wavelength conversion member 30 to the first holding section 651 can be prevented from decreasing, the temperature of the wavelength conversion member 30 can be prevented from excessively rising.

In the present embodiment, since the second holding section 652 only has to have a function of holding each of the first holding section 651 and the heat transfer member 270, high machining accuracy is not required for the second holding section 652. Therefore, since the machining accuracy for the second holding section 652, which is a part of the holding section 642, can be reduced, manufacturing cost and manufacturing man-hours for the support member 641 can be prevented from increasing.

The embodiments of the present disclosure are explained above. However, the technical scope of the present disclosure is not limited to the embodiments explained above, and various changes can be added to the embodiments without departing from the gist of the present disclosure. An aspect of the present disclosure can be a configuration obtained by combining, as appropriate, the characteristic portions of the embodiments explained above.

In the embodiments explained above, an example of applying the present disclosure to the light source device including the wavelength conversion member is cited. However, instead of the configuration, the present disclosure may be applied to a light source device that propagates incident light without performing wavelength conversion and thereafter controls, for example, an angle distribution and emits the incident light. In this case, the wavelength conversion member in the embodiments explained above is replaced with a light guide member, and the light emitted from the light emitting element is emitted to the angle conversion member as light having the same wavelength band.

The specific description of the shapes, the numbers, the dispositions, the materials, and the like of the elements of the light source device and the projector are not limited to those in the embodiments explained above and can be changed as appropriate. In the embodiments explained above, an example in which the light source device according to the present disclosure is mounted on the projector in which the liquid crystal panel is used is explained. However, the light source device is not limited to this. The light source device according to the present disclosure may be applied to a projector in which a digital micromirror device is used as a light modulation device. The projector may not include a plurality of light modulation devices and may include only one light modulation device.

In the embodiments explained above, an example in which the light source device according to the present disclosure is applied to the projector is explained. However, the light source device is not limited to this. The light source device according to the present disclosure can also be applied to a lighting instrument, a headlight of an automobile, and the like.

### SUMMARY OF THE PRESENT DISCLOSURE

A summary of the present disclosure is appended below.

### Appendix 1

A light source device including: a light source unit including a light emitting element configured to emit light; a light guide member on which the light emitted from the light emitting element is made incident, the light guide member emitting the light; and a support member configured to support the light guide member, wherein the support member includes: a support surface facing a first direction intersecting a longitudinal direction, which is a direction in which the light guide member extends, and configured to support the light guide member; a heat transfer member extending in a second direction intersecting the longitudinal direction; and a holding section configured to hold the heat transfer member, the heat transfer member is disposed on an inside of the holding section, and thermal conductivity of the heat transfer member is higher than thermal conductivity of the holding section.

With the light source device having this configuration, an amount of heat transferred from the wavelength conversion member to an outer surface facing in the second direction of the holding section by the heat transfer member can be increased. Therefore, since an amount of heat radiated from the wavelength conversion member to the outside of the light source device via the support member can be increased, the temperature of the wavelength conversion member can be prevented from excessively rising.

### Appendix 2

The light source device described in Appendix 1, wherein the second direction is a direction intersecting both of the longitudinal direction and the first direction.

With this configuration, the amount of the heat transferred from the wavelength conversion member to the outer surface facing the second direction of the holding section by the heat transfer member can be increased. Accordingly, the amount of the heat radiated from the wavelength conversion member to the outside of the light source device via the support member can be increased. Therefore, the temperature of the wavelength conversion member can be prevented from excessively rising.

### Appendix 3

The light source device described in Appendix 1, wherein the second direction is a direction inclined from the longitudinal direction to the first direction.

With this configuration, an amount of heat transferred from the wavelength conversion member to an outer surface facing a +D1 side of the holding section can be increased. Therefore, since the amount of the heat radiated from the wavelength conversion member to the outside of the light source device via the support member can be increased, the temperature of the wavelength conversion member can be prevented from excessively rising.

### Appendix 4

The light source device described in any one of Appendices 1 to 3, wherein at least a part of the heat transfer member overlaps the light guide member when viewed from the first direction.

With this configuration, the distance between the heat transfer member and the wavelength conversion member can be reduced. For that reason, the thermal resistance between the heat transfer member and the wavelength conversion member can be reduced. Accordingly, the amount of the heat transferred from the wavelength conversion member to the outer surface of the holding section by the heat transfer member can be more suitably increased. Therefore, the temperature of the wavelength conversion member can be more suitably prevented from excessively rising.

### Appendix 5

The light source device described in any one of Appendices 1 to 4, wherein the heat transfer member has a columnar shape or a tubular shape extending in the second direction.

With this configuration, the amount of the heat transferred from the wavelength conversion member to the outer surface facing the second direction of the holding section by the heat transfer member can be increased. Accordingly, the amount of the heat radiated from the wavelength conversion member to the outside of the light source device via the support member can be increased. Therefore, the temperature of the wavelength conversion member can be prevented from excessively rising.

### Appendix 6

The light source device described in any one of Appendices 1 to 4, wherein the heat transfer member is a tubular heat pipe extending in the second direction.

With this configuration, the amount of the heat transferred from the wavelength conversion member to the outer surface facing the second direction of the holding section by the heat transfer member can be increased. Therefore, since the amount of the heat radiated from the wavelength conversion member to the outside of the light source device via the support member can be increased, the temperature of the wavelength conversion member can be more suitably prevented from excessively rising.

### Appendix 7

The light source device described in any one of Appendices 1 to 6, wherein the support member includes a plurality of the heat transfer members, and the plurality of heat transfer members are disposed in the longitudinal direction.

With this configuration, temperature variation of the wavelength conversion member in the longitudinal direction is easily reduced. Accordingly, since the temperature of a part of the wavelength conversion member can be suitably prevented from excessively rising in the longitudinal direction, the temperature of the entire wavelength conversion member can be more suitably reduced.

### Appendix 8

The light source device described in any one of Appendices 1 to 4, wherein the heat transfer member is a plate-shaped vapor chamber spreading in a direction intersecting the first direction.

With this configuration, temperature variation of the support surface in the longitudinal direction is easily suppressed. Therefore, variation in an amount of heat transferred from the wavelength conversion member to the support member in the longitudinal direction can be suitably suppressed. For that reason, temperature variation of the wavelength conversion member in the longitudinal direction can be suitably suppressed. Therefore, the temperature of a part of the wavelength conversion member in the longitudinal direction can be more suitably prevented from excessively rising.

### Appendix 9

The light source device described in Appendix 8, wherein a plate surface of the heat transfer member faces the first direction, and the support surface includes a surface facing the first direction among outer surfaces of the heat transfer member.

With this configuration, since the thermal resistance between the wavelength conversion member and the heat transfer member can be reduced, the amount of the heat transferred from the wavelength conversion member to the heat transfer member can be suitably increased. Therefore, since the amount of the heat radiated from the wavelength conversion member to the outside of the light source device via the support member can be increased, the temperature of the wavelength conversion member can be prevented from excessively rising.

### Appendix 10

The light source device described in any one of Appendices 1 to 9, further including a pressing member that presses the light guide member against the support surface, wherein a portion of the light guide member pressed by the pressing member overlaps the heat transfer member when viewed from the first direction.

With this configuration, the thermal resistance between the portion of the wavelength conversion member pressed by the pressing member and the heat transfer member can be reduced. For that reason, the amount of the heat transferred from the wavelength conversion member to the heat transfer member can be more suitably increased. Accordingly, the amount of the heat radiated from the wavelength conversion member to the outside of the light source device via the support member can be more suitably increased. Therefore, the temperature of the wavelength conversion member can be more suitably prevented from excessively rising.

### Appendix 11

The light source device described in Appendix 10, wherein the light source device includes a plurality of the pressing members disposed spaced apart in the longitudinal direction, the support member includes a plurality of fixed sections disposed spaced apart in the longitudinal direction, the plurality of pressing members are respectively fixed to the fixed sections different from one another, and at least parts of the heat transfer member are disposed among the plurality of fixed sections in the longitudinal direction.

With this configuration, an amount of heat transferred from portions of the support surface in contact with portions among the plurality of fixed sections of the wavelength conversion member to the outer surface facing the second direction of the holding section can be increased. Accordingly, since the temperature difference between the portions of the wavelength conversion member among the plurality of fixed sections and the support surface can be increased, an amount of heat transferred from a second portion to the holding section can be increased. Therefore, the temperature of the portions of the wavelength conversion member among the plurality of fixed sections can be more suitably prevented from excessively rising.

### Appendix 12

The light source device described in any one of Appendices 1 to 11, wherein the holding section includes a first holding section including the support surface and a second holding section configured to hold the first holding section, and the heat transfer member is disposed on an inside of the second holding section.

With this configuration, a hole for housing the heat transfer member does not need to be provided in the first holding section. Therefore, since the flatness of the support surface can be prevented from decreasing, the thermal resistance between the wavelength conversion member and the support surface can be prevented from increasing. Therefore, since the amount of the heat transferred from the wavelength conversion member to the first holding section can be prevented from decreasing, the temperature of the wavelength conversion member can be prevented from excessively rising.

### Appendix 13

The light source device described in any one of Appendices 1 to 12, further including a heat sink attached to a surface facing a side opposite to the support surface among outer surfaces of the holding section.

With this configuration, an amount of heat radiated from the support member to the outside of the light source device via the heat sink can be increased. Therefore, since an amount of heat radiated from the wavelength conversion member to the outside of the light source device via the support member and the heat sink can be increased, the temperature of the wavelength conversion member can be more suitably prevented from excessively rising.

### Appendix 14

The light source device described in any one of Appendices 1 to 13, wherein the light emitting element emits first light having a first wavelength band, and the light guide member is a wavelength conversion member that includes a phosphor, converts the first light into second light having a second wavelength band different from the first wavelength band, and emits the second light.

With this configuration, the temperature of the wavelength conversion member can be prevented from excessively rising. Therefore, since temperature quenching of the second light in the wavelength conversion member can be reduced, wavelength conversion efficiency of the wavelength conversion member can be prevented from decreasing.

### Appendix 15

A projector including: the light source device described in any one of Appendices 1 to 14; a light modulation device configured to modulate light emitted from the light source device; and a projection optical device configured to project the light modulated by the light modulation device.

With the projector having this configuration, since the wavelength conversion efficiency in the wavelength conversion member can be increased, an amount of the second light emitted from the wavelength conversion member can be increased. Accordingly, an amount of the first light necessary for emitting a predetermined amount of the second light can be reduced. Therefore, since an amount of the first light emitted by the light emitting element can be reduced, electric power consumed by the projector can be reduced.

What is claimed is:

1. A light source device comprising:
a light source unit including a light emitting element configured to emit light;
a light guide member on which the light emitted from the light emitting element is made incident, the light guide member emitting the light; and
a support member configured to support the light guide member, wherein
the support member includes:
a support surface facing a first direction intersecting a longitudinal direction, which is a direction in which the light guide member extends, and configured to support the light guide member;
a heat transfer member extending in a second direction intersecting the longitudinal direction; and
a holding section configured to hold the heat transfer member,
the heat transfer member is disposed on an inside of the holding section, and
thermal conductivity of the heat transfer member is higher than thermal conductivity of the holding section.

2. The light source device according to claim 1, wherein the second direction is a direction intersecting both of the longitudinal direction and the first direction.

3. The light source device according to claim 1, wherein the second direction is a direction inclined from the longitudinal direction to the first direction.

4. The light source device according to claim 1, wherein at least a part of the heat transfer member overlaps the light guide member when viewed from the first direction.

5. The light source device according to claim 1, wherein the heat transfer member has a columnar shape or a tubular shape extending in the second direction.

6. The light source device according to claim 1, wherein the heat transfer member is a tubular heat pipe extending in the second direction.

7. The light source device according to claim 1, wherein
the support member includes a plurality of the heat transfer members, and
the plurality of heat transfer members are disposed in the longitudinal direction.

8. The light source device according to claim 1, wherein the heat transfer member is a plate-shaped vapor chamber spreading in a direction intersecting the first direction.

9. The light source device according to claim 8, wherein
a plate surface of the heat transfer member faces the first direction, and
the support surface includes a surface facing the first direction among outer surfaces of the heat transfer member.

10. The light source device according to claim 1, further comprising a pressing member that presses the light guide member against the support surface, wherein
a portion of the light guide member pressed by the pressing member overlaps the heat transfer member when viewed from the first direction.

11. The light source device according to claim 10, wherein
the light source device comprises a plurality of the pressing members disposed spaced apart in the longitudinal direction,
the support member includes a plurality of fixed sections disposed spaced apart in the longitudinal direction,
the plurality of pressing members are respectively fixed to the fixed sections different from one another, and
at least parts of the heat transfer member are disposed among the plurality of fixed sections in the longitudinal direction.

12. The light source device according to claim 1, wherein
the holding section includes a first holding section including the support surface and a second holding section configured to hold the first holding section, and
the heat transfer member is disposed on an inside of the second holding section.

13. The light source device according to claim 1, further comprising a heat sink attached to a surface facing a side opposite to the support surface among outer surfaces of the holding section.

14. The light source device according to claim 1, wherein
the light emitting element emits first light having a first wavelength band, and
the light guide member is a wavelength conversion member that includes a phosphor, converts the first light into second light having a second wavelength band different from the first wavelength band, and emits the second light.

15. A projector comprising:
the light source device according to claim 1;
a light modulation device configured to modulate light emitted from the light source device; and
a projection optical device configured to project the light modulated by the light modulation device.
